(19) United States
(12) Patent Application Publication
(10) Pub. No.: US 2026/0234914 A1
(43) Pub. Date: Aug. 13, 2026

(54) TOP MOUNT INSTALLATION

(71) Applicant: Kohler Co., Kohler, WI (US)

(72) Inventors: Alejandra Lazarini, Charlotte, NC (US); Rayven Hao, Glendale, WI (US); Thomas E. Lilly, Shelby Township, MI (US); Tyler Doro, Kohler, WI (US); Jason J. Kim, Brookhaven, GA (US)

(21) Appl. No.: 19/530,248

(22) Filed: Feb. 4, 2026

Related U.S. Application Data
(60) Provisional application No. 63/782,761, filed on Apr. 3, 2025.
(60) Provisional application No. 63/758,139, filed on Feb. 13, 2025.

(51) Int. Cl. E03C 1/04

(52) U.S. Cl. CPC E03C 1/0402

(57) ABSTRACT

A top mount installation enables a user to mount a fixture on a surface of a structure from a readily accessible area adjacent to the structure. The top mount installation includes a base connectable to the fixture and an anchor that cooperates with the base to create a clamp on the structure. The anchor is joined to a sleeve that engages, e.g., receives or is received by, a shaft extending from the base. The sleeve and the anchor can be movable relative to the shaft towards the base via threaded engagement between a fastener and the sleeve. The shaft and the sleeve can also include complementing anti-rotation shapes that limit relative rotation between the shaft and the sleeve during engagement between the fastener and the sleeve, allowing such engagement to cause movement of the sleeve and the anchor towards the base.

### CROSS-REFERENCE TO RELATED APPLICATIONS

This application claims priority to and the benefit of U.S. Provisional Application No. 63/758,139, filed February 13, 2025, and U.S. Provisional Application No. 63/782,761, filed April 3, 2025, the entire disclosures of which are hereby incorporated herein by reference.

### FIELD

The field of disclosure relates generally to faucets and other countertop fixtures. In particular, the present disclosure relates to systems and methods for installing a faucet from above a countertop.

### BACKGROUND

When installing a faucet, the faucet is typically mounted to a countertop. A fastener, such as a nut and a large washer or plate, is attached to a body of the faucet mount from beneath a countertop. The user accesses the space below the countertop to install the faucet. A need exists for an installation that enables mounting a faucet on a countertop from above the countertop, which may reduce the number of installation tasks performed below the countertop.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 is an exploded perspective view of an example faucet with a top mount installation.

FIG. 2 is an exploded perspective view of an example faucet with a top mount installation.

FIG. 3 is an exploded perspective view of an example faucet with a top mount installation.

FIG. 4 is a side cross-section of an example faucet with a top mount installation.

FIG. 5 is an exploded perspective view of an example faucet with a top mount installation.

FIG. 6 is a side cross-section of an example faucet handle with a top mount installation.

FIG. 7 is a perspective view of an example top mount installation.

FIG. 8 is an exploded perspective view of an example top mount installation.

FIG. 9 is a top plan view of an example top mount installation.

FIG. 10 is a side cross-section of an example top mount installation.

FIGS. 11-15 depict a sequence of installing of an example top mount installation on a countertop.

FIG. 16 is a perspective view of an example top mount installation.

FIG. 17 is an exploded perspective view of an example top mount installation.

FIG. 18 is a side elevation view of an example top mount installation.

FIG. 19 is a top plan view of an example top mount installation.

FIG. 20 is a side cross-section of an example top mount installation.

FIGS. 21 and 22 are perspective views of an example top mount installation having an anchoring arm that is movable between a vertical orientation shown in FIG. 21 and a horizontal orientation shown in FIG. 22.

FIGS. 23 and 24 are rear elevation views of an example top mount installation having an anchoring arm that is movable between a vertical orientation shown in FIG. 23 and a horizontal orientation shown in FIG. 24.

FIGS. 25-28 depict a sequence of installing an example top mount installation on a countertop.

FIGS. 29 and 30 depict a sequence of installing an example top mount installation on a countertop.

FIGS. 31 and 32 are perspective views of an example top mount installation having two anchoring arms that are movable between a vertical orientation shown in FIG. 31 and a horizontal orientation shown in FIG. 32.

FIGS. 33 and 34 are top plan views of an example top mount installation having two anchoring arms that are movable between a vertical orientation shown in FIG. 33 and a horizontal orientation shown in FIG. 34.

FIG. 35 is an exploded perspective view of an example top mount installation.

FIG. 36 is a side cross-section of an example top mount installation.

FIG. 37 is a perspective view of an example top mount installation.

FIG. 38 is an exploded perspective view of an example top mount installation.

FIG. 39 is a top plan view of an example top mount installation.

FIG. 40 is a bottom plan view of an example top mount installation.

FIG. 41 is a side cross-section of an example top mount installation.

FIGS. 42 and 43 are perspective views of an example top mount installation having a butterfly anchor that is movable between an open orientation shown in FIG. 42 and a closed orientation shown in FIG. 43.

FIGS. 44 and 45 are top plan views of an example top mount installation having a butterfly anchor that is movable between an open orientation shown in FIG. 44 and a closed orientation shown in FIG. 45.

FIG. 46 is an exploded perspective view of an example top mount installation.

FIG. 47 is a side cross-section of an example top mount installation.

FIG. 48 is a perspective view of an example top mount installation.

FIG. 49 is an exploded perspective view of an example top mount installation.

FIGS. 50 and 51 are perspective views of an example top mount installation having two anchoring bars that are movable between a vertical orientation shown in FIG. 50 and a horizontal orientation shown in FIG. 51.

FIGS. 52 and 53 are top plan views of an example top mount installation having two anchoring bars that are movable between a vertical orientation shown in FIG. 52 and a horizontal orientation shown in FIG. 53.

FIG. 54 is a side cross-section of an example top mount installation having two anchoring bars in a vertical orientation.

FIG. 55 is a side cross-section of an example top mount installation having two anchoring bars in a horizontal orientation.

FIG. 56 is a top plan view of an example top mount installation having two anchoring members in a vertical orientation.

FIG. 57 is a perspective view of an example top mount installation.

FIG. 58 is a side cross-section of an example top mount installation.

FIG. 59 is a side elevation of an example top mount installation.

FIG. 60 is a top plan view of an example top mount installation.

FIG. 61 is a perspective view of an example top mount installation.

Corresponding reference numbers in the drawings indicate corresponding parts.

### DETAILED DESCRIPTION

Aspects of the present disclosure relate to top mount installations that enable a user to mount a fixture on a surface of a structure more easily and from a readily accessible area adjacent to the structure. The top mount installations may reduce or eliminate the number of tasks that require the user to physically access adjacent areas that are hard or inconvenient to access or otherwise make the mounting process more difficult, time consuming, and/or dangerous. For example, the top mount installations may be used to mount a faucet on a countertop from a top of the countertop that is readily accessible to the user. In this way, the number of tasks that require user access to a space below the countertop for installing the faucet may be reduced or eliminated. The top mount installations also make the installation and mounting process easier and quicker, and require fewer components and tools.

A top mount installation may include a base connectable to the fixture, such as a faucet, and an anchor that cooperates with the base to create a clamp on the structure, such as a countertop. The base is positioned above the surface of the structure on which the fixture is mounted, such as the top of a countertop for the faucet. The anchor is insertable through the structure, such as via a hole in the countertop, and is movable relative to the base to a clamping position in which an anchoring surface of the anchor engages another surface of the structure, such as the bottom of the countertop. The anchor is joined to a sleeve that engages, e.g., receives or is received by, a shaft extending from the base. The sleeve and the anchor are movable relative to the shaft to move the anchor towards the base to the clamping position. Movement of the sleeve and the anchor can be caused via threaded engagement between a fastener within the sleeve. The shaft and the sleeve can also include complementing anti-rotation shapes that limit relative rotation between the shaft and the sleeve during engagement between the fastener and the sleeve, allowing the engagement between the fastener and the sleeve to translate rotation of the fastener to movement of the sleeve and the anchor relative to the shaft towards the base.

The following description and the appended figures set forth certain features for purposes of illustration. Advantages will become more apparent when reading the present disclosure in its entirety.

One or more specific embodiments of the present disclosure are described. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

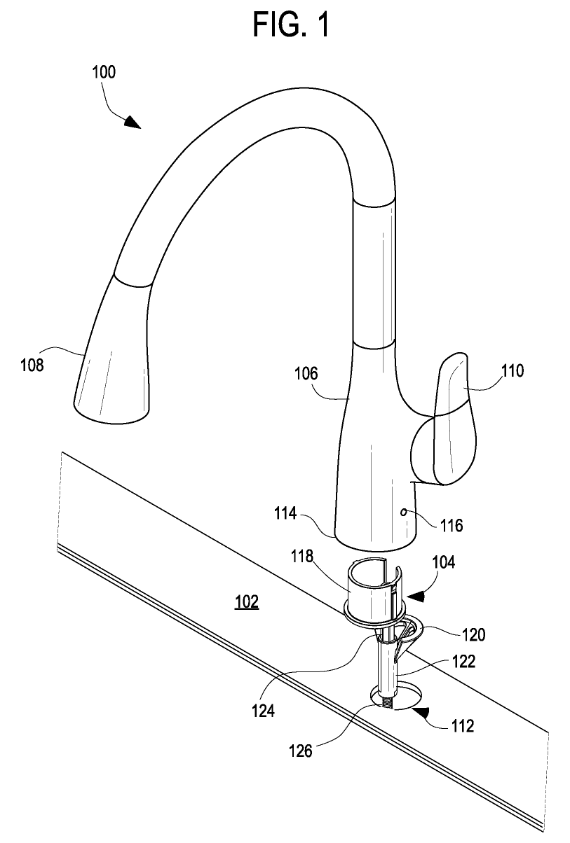

FIG. 1 depicts a fixture that can be mounted on a structure via a top mount installation 104. The fixture in this example is a faucet 100 and the structure is a countertop 102. The top mount installation 104 enables a user to install the faucet 100 on the countertop 102 from the top. The top mount installation 104 may reduce or eliminate the numbers of tasks for installing the faucet 100 that require user access to a bottom of the countertop 102 or a space below the countertop 102. Additionally, the top mount installation 104 may require fewer parts and/or tools for installing the faucet 100. The top mount installation 104 may also enable installing the faucet 100 on the countertop 102 from the top in a quick and user-friendly manner.

The example faucet 100 includes a body 106 that includes a spout 108 and a handle 110. The spout 108 may dispense water or other liquid and the handle 110 can be actuated via the user for controlling flow of the water from the spout 108. The handle 110 may be located on a side of the body 106. The body 106 may have a hollow interior to accommodate water hoses or conduits that connect the faucet 100 to a supply of water via a hole 112 in the countertop 102. A bottom 114 of the body 106 may connect to the top mount installation 104 via a set screw 116, or another suitable retainer such as a key or another fastener. For example, the top mount installation 104 may be installed on the countertop 102 and the body 106 can then be connected to the top mount installation 104 via the set screw 116, with the top mount installation 104 anchoring the faucet 100 on the countertop 102.

The top mount installation 104 includes a base 118 and an anchor 120. The base 118 can be positioned above a first surface, here a top surface, of the countertop 102. The anchor 120 anchors or secures the top mount installation 104 to the countertop 102. The anchor 120 can be inserted into the hole 112 from the top of the countertop 102 and is movable relative to the base 118 to a clamping position. The anchor 120 contacts a second surface, here a bottom surface, of the countertop 102 in the clamping position, creating a clamp on the countertop 102 with the base 118. The anchor 120 may include or be coupled to an anti-rotation sleeve 122 that engages, e.g., receives or is received by, an anti-rotation shaft 124 extending from the base 118. The anti-rotation sleeve 122 may receive the anti-rotation shaft 124. Alternatively, the anti-rotation shaft 124 may receive the anti-rotation sleeve 122. The anti-rotation sleeve 122 and anti-rotation shaft 124 can have complementing anti-rotation shapes. The complementing anti-rotation shapes may cooperate to limit or prevent rotation of the anchor 120 relative to the shaft 124 and the base 118 when the anchor 120 is moved to the clamping position.

The anti-rotation shaft 124 and the anti-rotation sleeve 122 each accommodate a clamping bolt 126. The clamping bolt 126 is operatively coupled with the anti-rotation sleeve 122 and accessible at the base 118 for a user to manipulate the bolt 126. The user can manipulate the bolt 126 using a screwdriver, wrench, or another suitable tool from a convenient location, e.g., above the countertop 102. For example, the user may manipulate the bolt 126 using a screwdriver with a hex insert. The clamping bolt 126 is able to rotate within and relative to the anti-rotation sleeve 122 and the anti-rotation shaft 124. The clamping bolt 126 engages the anti-rotation sleeve 122 such that rotation of the clamping bolt 126 causes upward and downward movement of the anti-rotation sleeve 122 relative to the shaft 124. For example, the clamping bolt 126 can engage interior threads of the anti-rotation sleeve 122 to move the sleeve 122. The clamping bolt 126 may move the sleeve 122 upward towards the base 118 when tightened and downwards away from the base 118 when loosened. The user can tighten the clamping bolt 126 to move the anti-rotation sleeve 122 and the anchor 120 upwards toward the base 118 to the clamping position.

Movement of the sleeve 122 relative to the shaft 124 via rotation of the bolt 126 may be facilitated via the complementing anti-rotation shapes of the sleeve 122 and the shaft 124. More particularly, the complementing anti-rotation shapes of the sleeve 122 and the shaft 124 limit or restrict relative rotation between the shaft 124 and the sleeve 122 while the bolt 126 is able to rotate. The rotation of the bolt 126 relative to the sleeve 122 can translate to vertical movement of the sleeve 122 relative to the shaft 124 via threaded engagement between the bolt 126 and the sleeve 122. The anti-rotation shapes thereby control the rotational relation between the sleeve 122, the shaft 124, and the bolt 126. Accordingly, the top mount installation 104 can be greatly simplified and enables the user to more easily install the top mount installation 104 on the countertop 102.

When the anchor 120 is positioned underneath the countertop 102, the anchor 120 can move to the clamping position and into contact with the bottom surface of the countertop 102. The base 118 may be sized and shaped to be seated on and/or above the countertop 102 and the hole 112 without being fully insertable through the hole 112. As such, when the anchor 120 is in the clamping position, the base 118 and anchor 120 create a clamp with the countertop 102 and secure the top mount installation thereon. The body 106 of the faucet 100 can then be installed and the base 118 above the countertop 102 is received by the bottom 114 of the body 106. The body 106 can then be connected to the base 118 via the set screw 116 or another suitable retainer.

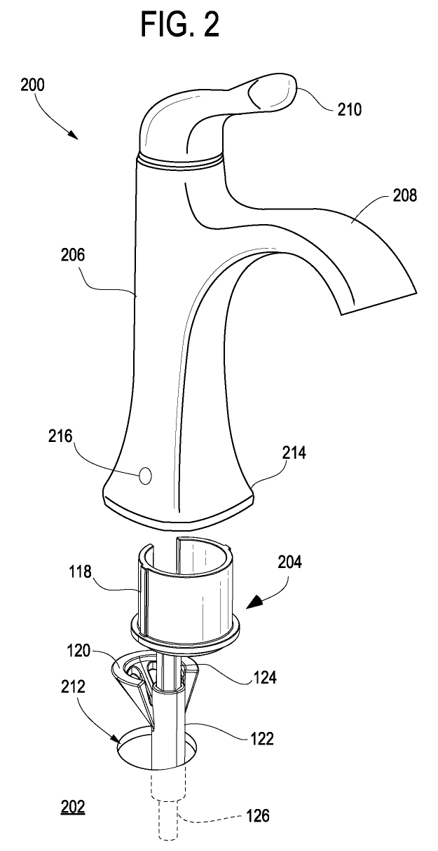

FIG. 2 depicts another fixture that can be installed on a structure via a top mount installation 204. Here again, the fixture is a faucet 200 and the structure is a countertop 202. The top mount installation 204 may be similar to the top mount installation 104, with like reference numbers used to indicate like parts. For brevity and conciseness, differences between the faucet 200 and the faucet 100 may be described. Similarities between the faucet 200 and the faucet 100 can be recognized from FIGS. 1 and 2.

The example faucet 200 includes a body 206 that includes a spout 208 and a handle 210, similar to the body 106 of the faucet 100 described above. The handle 210 in this example may be located on a top of the body 206. The body 206 may have a hollow interior to accommodate water hoses or conduits that connect the faucet 200 to a supply of water via a hole 212 in the countertop 202. A bottom 214 of the body 206 may connect to the top mount installation 204 via a set screw 216, or another suitable retainer such as a key or another fastener. For example, the top mount installation 204 may be installed on the countertop 202 and the body 206 can then be connected to the top mount installation 204 via the set screw 216, with the top mount installation 204 anchoring the faucet 200 on the countertop 202.

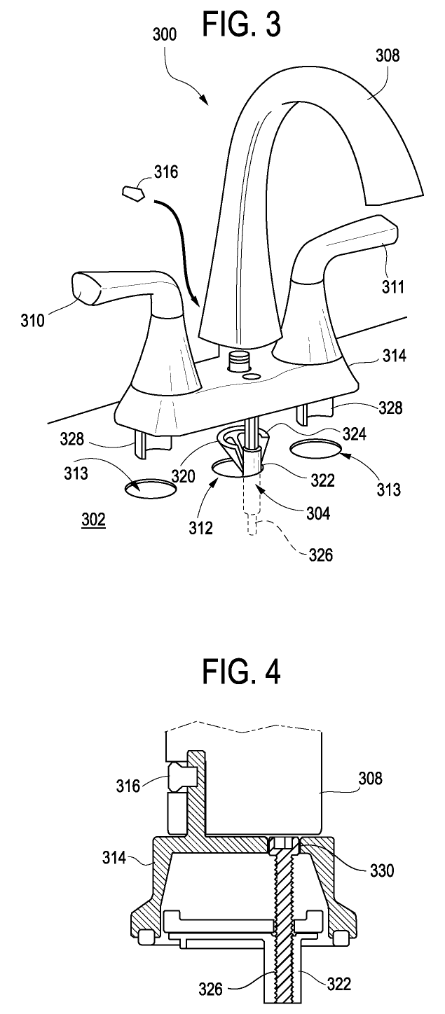

FIG. 3 depicts another fixture that can be installed on a structure via a top mount installation 304. Here again, the fixture is a faucet 300 and the structure is a countertop 302. The top mount installation 304 may be similar to the top mount installation 104. For brevity and conciseness, differences between the faucet 300 and the faucets 100, 200 may be described. Similarities between the faucet 300 and the faucets 100, 200 can be recognized from FIGS. 1-3.

The example faucet 300 includes an escutcheon 314 that has two handles 310, 311. The handles 310, 311 may be individually actuated via the user for controlling flow of hot water or cold water from a spout 308. The spout 308 may be connected to the escutcheon 314 via a set screw 316, or another suitable retainer such as a key or another fastener. The escutcheon 314 is mounted on the countertop 302 and may include, or may be coupled to, a shaft 324 of the top mount installation 304. The top mount installation 304 also includes a sleeve 322 with a complementary anti-rotation shape to the shaft 324, similar to the sleeve 122 and shaft 124 described above. A clamping bolt 326 of the top mount installation 304 is accommodated in the sleeve 322 and shaft 324.

Movement of the sleeve 322 towards the escutcheon 314 causes an anchor 320 of the top mount installation 304 to move towards a bottom of the countertop 302. The anchor 320 may contact the bottom of the countertop 302 in a clamping position. The anchor 320 in the clamping position can secure or anchor the escutcheon 314 on the countertop 302. The anchor 320, sleeve 322, and shaft 324 are inserted through a center hole 312 of the countertop 302, which may be covered by the escutcheon 314. The countertop 302 may also include side holes 313 that receive lugs 328 of the escutcheon 314 for locating the escutcheon 314 on the countertop 302 and/or preventing lateral movement of the escutcheon 314 relative to the countertop 302.

Referring to FIG. 4, the clamping bolt 326 may be accessible via a through hole 330 of the escutcheon 314 for a user to manipulate the set screw 316. The user can manipulate the bolt 326 using a screwdriver, wrench, or another suitable tool from a convenient location, e.g., above the countertop 302. For example, the user may manipulate the bolt 326 using a screwdriver with a hex insert. The clamping bolt 326 may rotate in the sleeve 322 and shaft 324 and can threadedly engage the sleeve 322. Engagement between the bolt 326 and the sleeve 322 can translate rotation of the bolt 326 to vertical movement of the sleeve 322 towards and away from the escutcheon 314 as described above.

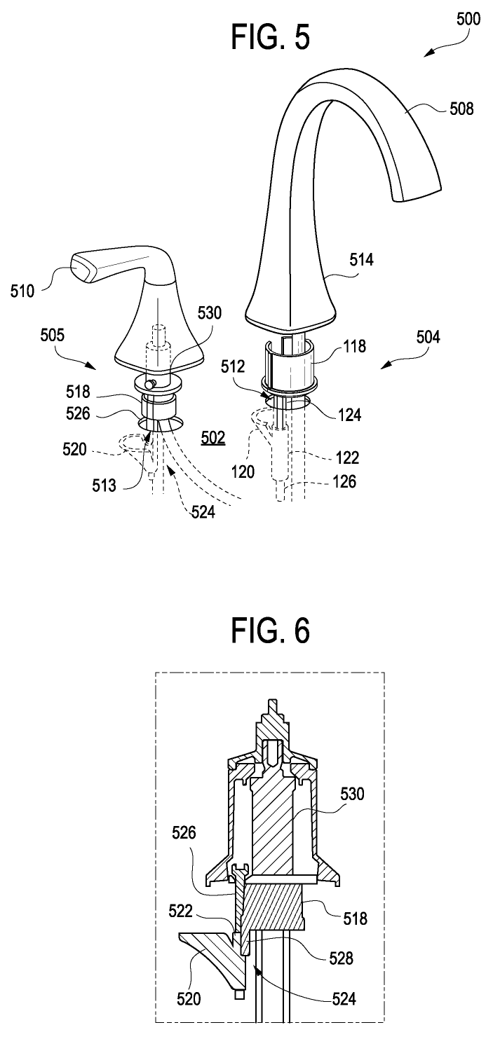

FIG. 5 depicts another example of fixtures that can be installed on a structure via a top mount installations 504, 505. In this example, the fixtures form a faucet 500 and include a spout 508 and a handle 510. The structure is a countertop 502. The spout 508 and the handle 510 may be individually mounted on the countertop 502 via a respective top mount installation 504, 505. The top mount installations 504, 505 may be similar to the top mount installations 104, 304 described above. For brevity and conciseness, differences between the faucet 500 and the faucets 100, 200, 300 may be described. Similarities between the faucet 500 and the faucets 100, 200, 300 can be recognized from FIGS. 1-3 and 5.

The spout 508 is secured or anchored to the countertop 502 at a bottom 514 via a first top mount installation 504. The first top mount installation 504 may include similar features and components as the top mount installation 104 of FIG. 1, with like features and components indicated using like reference numbers. The first top mount installation 304 may be located at a first hole 512 of the countertop 502.

The handle 510 is secured or anchored to the countertop 502 via a second top mount installation 505. The second top mount installation 505 may be located at a second hole 513 of the countertop 502. The second top mount installation 505 includes a base 518 that may be seated at the second hole 513. The base 518 may be coupled to, or integrated with, a mounting structure 530 of the handle 510. The mounting structure 530 may be mounted on the countertop 502 above the second hole 513. The mounting structure 530 may secure the base 518 relative to the countertop 502. The second top mount installation 505 also includes an anchor 520 that is movably coupled to the base 518. For example, the anchor 520 may be coupled to the base 518 via an interlock 524. The anchor 520 is movable towards and away from the base 518 between a clamping and a non-clamping position. Movement of the anchor 520 can be controlled via a clamping bolt 526 that is received by an interlock sleeve 522 of the anchor 520.

Referring to FIG. 6, the interlock sleeve 522 may cooperate with a shaft or tail 528 of the base 518 to form the interlock 524. For example, the interlock sleeve 522 may receive the tail 528 of the base 518 to form the interlock 524. Alternatively, the tail 528 of the base 518 may receive the interlock sleeve 522. The clamping bolt 526 may be accessible via the mounting structure 530. A user can manipulate the bolt 526 using a screwdriver, wrench, or another suitable tool from a convenient location, e.g., above the countertop 502. For example, the user may manipulate the bolt 526 using a screwdriver with a hex insert. The clamping bolt 526 may threadedly engage within the interlock sleeve 522. Rotation of the clamping bolt 526 is translated to vertical movement of the sleeve 522 towards and away from the base 518. The interlock sleeve 522 may also be secured rotationally relative to the tail 528 of the base 518 such that rotation of the anchor 520 relative to the base 518 is limited or prevented. The interlock 524 may thereby function as an anti-rotation mechanism between the anchor 520 and the base 518 while enabling the anchor 520 to move vertically between the clamping position and the non-clamping position. In the clamping position, the anchor 520 may contact a bottom of the countertop 502, securing or anchoring the base 518 and the mounting structure 530 on the countertop 502.

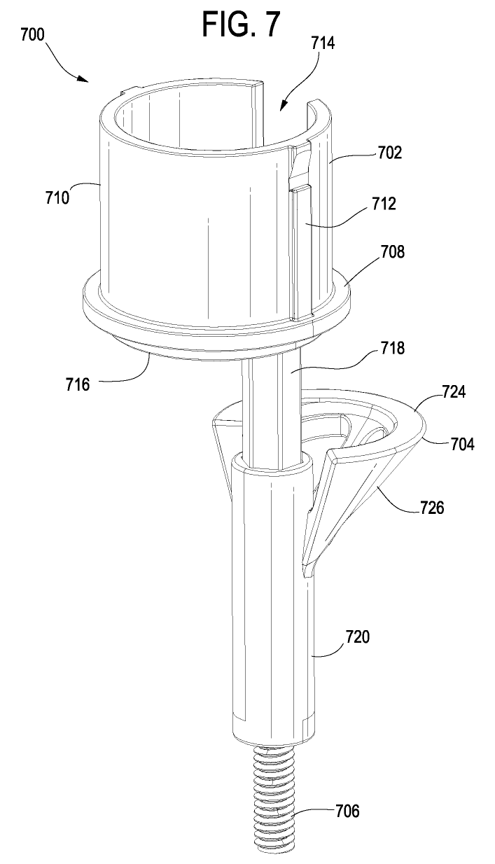

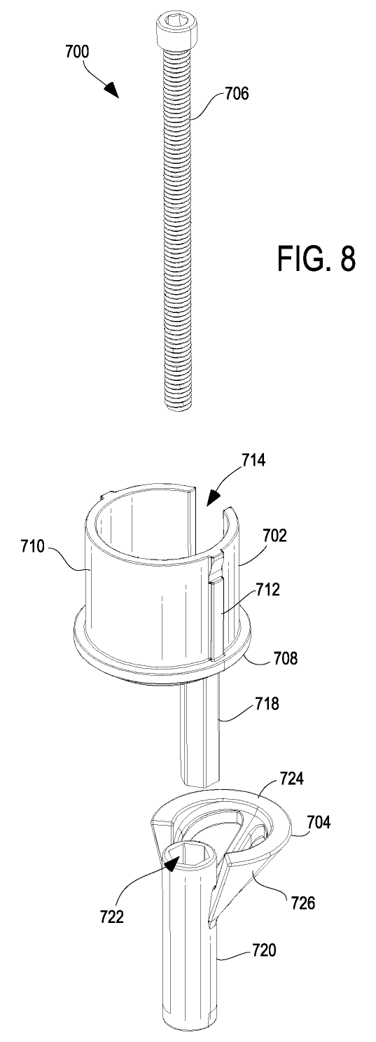

Referring now to FIGS. 7 and 8, an example of a top mount installation that can be used to mount a fixture on a structure is shown isolated and indicated generally at 700. The top mount installation 700 can be used to mount any one of the faucets 100, 200, 300, 500 on the countertop 102, 202, 302, 502. The top mount installation 700 includes a base 702 and an anchor that is movable relative to the base 702 between a clamping position and a non-clamping position. The anchor may include an anchoring collar 704. The anchoring collar 704 can move via a user manipulating a clamping bolt 706 from a convenient location, e.g., above a countertop. In the clamping position, the anchoring collar 704 contacts a second surface, here a bottom surface, of the countertop. The anchoring collar 704 in the clamping position cooperates with a flange 708 of the base 702 to create a clamp on the countertop. The flange 708 contacts a first surface, here a top surface, of the countertop and limits or prevents the base 702 from being fully inserted through the countertop. Additionally or alternatively, the flange 708 contacts a top surface of an escutcheon or other mounting structure positioned on the countertop.

The base 702 may include a cylindrical body 710 that is positioned above the countertop when the top mount installation 700 is installed. The body 710 may be sized and shaped for insertion into a bottom of a fixture, such as a faucet spout or a handle of a faucet. The body 710 may include ridges 712 that enable orienting and piloting the fixture on the base 702. The base 702 may be open at both ends to enable a user to route conduits, hoses, or other connections through the base 702 and the structure such as a countertop. The body 710 may also include a cut-out 714 that accommodates a head of the clamping bolt 706. The user can access and manipulate the bolt 706 from a top of the structure via the cut-out 714. Additionally or alternatively, the user can access and manipulate the bolt 706 from an open top end of the base 702.

The flange 708 may extend radially outward from the body 710 of the base 702 proximate a bottom of the body 710. The flange 708 may be vertically offset from a bottom of the body 710, such that a portion of the body 710 extends below the flange 708. The portion of the body 710 below the flange 708 may define a pilot 716 that is inserted in a hole in the countertop for locating the base 702 on the countertop. Additionally or alternatively, the pilot 716 may be inserted in a hole of an escutcheon or other mounting structure positioned on the countertop. The pilot 716 may be long enough to extend within a hole in an escutcheon or other mounting structure and within a hole in the countertop. The pilot 716 may engage within the hole to limit or prevent lateral movement of the top mount installation 700 relative to the countertop.

The top mount installation 700 also includes an anti-rotation shaft 718. The anti-rotation shaft 718 may be joined to the body 710 and may extend downward from the base 702. The shaft 718 may be coupled to the body 710 or may be made integral with the body 710 as a one-piece unit. The shaft 718 may be tubular and may accommodate the clamping bolt 706. The shaft 718 may be sized and shaped to enable the clamping bolt 706 to rotate within the shaft 718.

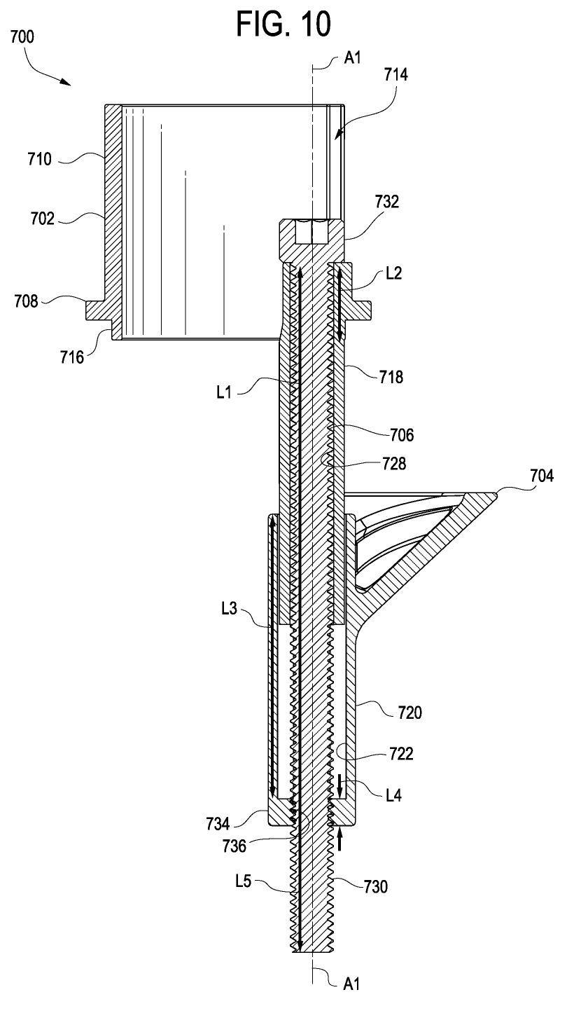

The shaft 718 also has an anti-rotation shape that complements an anti-rotation sleeve 720. The anti-rotation sleeve 720 may be joined to the anchoring collar 704. The anti-rotation sleeve 720 may be coupled to the anchoring collar 704 or may be integrated with the anchoring collar 704. The anti-rotation shaft 718 may engage the anti-rotation sleeve 720 to limit relative rotation between the shaft and the sleeve. The anti-rotation sleeve 720 may define a bore 722 that is aligned with a center passage 728 (FIG. 10) of the shaft 718 when the shaft and the sleeve are engaged. The bore 722 may receive the shaft 718. The shaft 718 and the bore 722 may have complementing anti-rotation shapes. The anti-rotation shapes may limit or prevent rotation of the shaft 718 within the bore 722. For example, the shaft 718 and the bore 722 may have a hexagonal shape. In other examples, the shaft 718 and the bore 722 have any complementing anti-rotation shape that limits or prevents rotation of the shaft 718 in the bore 722. For example, the shaft 718 and the bore 722 may have a complementing polygonal shape, oblong shape, oval shape, or other anti-rotation shape such as any shape other than a circular shape. Alternatively, the center passage 728 of the shaft 718 may receive the sleeve 720, and the center passage and the sleeve may have any of the complementing anti-rotation shapes described above.

The clamping bolt 706 may extend through the shaft 718 and the bore 722. The bolt 706 can threadedly engage within the bore 722 such that rotation of the clamping bolt 706 is translated to vertical movement of the sleeve 720 relative to the shaft 718. Interaction between the bolt 706 and bore 722 and movement of the sleeve 720 relative to the shaft 718 is described below with reference to FIG. 10.

The anchoring collar 704 may be flared outward from the sleeve 720 to an anchor surface 724. The anchor surface 724 may face the bottom of the countertop when the top mount installation 700 is installed. The anchoring surface 724 may also contact the bottom of the countertop when the anchoring collar 704 is moved to the clamping position. The outward flare of the anchoring collar 704 may be defined by a tapered sidewall 726 joined to the sleeve 720. The sidewall 726 may be coupled to the sleeve 720 or may be made integral with the sleeve 720 as a one-piece unit. The sidewall 726 in this example may have a semi-conical shape and the anchor surface 724 may corresponding have a semi-circular shape. The shape of the sidewall 726 and anchor surface 724 may complement a shape of a hole in the countertop through which the anchoring collar 704 and sleeve 720 are inserted. For example, the semi-conical sidewall 726 and semi-circular anchor surface 724 may complement a circular shape of the hole. The shape of the anchoring collar 704 is not limited, however, and can be any shape complementing a shape of the hole in the countertop through which the anchoring collar 704 is inserted.

The shaft 718 may be joined to the base 702. The shaft 718 may be coupled to the base 702 or may be integrated with the base 702. The shaft 718 can be joined to the base 702 at or proximate a side of the body 710. The body 710 extends circumferentially and outward from the shaft 718 and in an opposite direction from the anchoring collar 704. The shaft 718 may be joined to an inner surface of the body 710 and/or a bottom of the pilot 716. The shaft 718 may extend downward from the pilot 716 without extending radially outward beyond the pilot 716 so as not to interfere with engagement between the base 702 and the countertop or mounting structure.

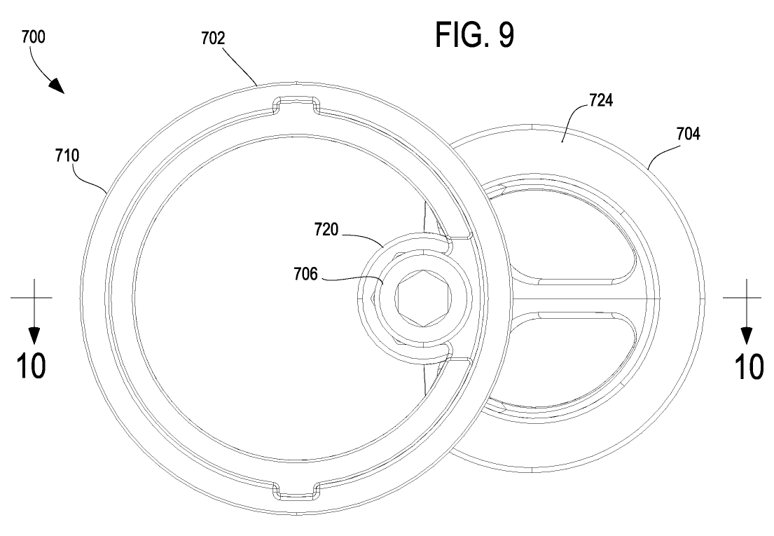

Referring to FIG. 9, the anchoring collar 704 may be laterally or radially offset from the body 710 of the base 702. The offset between the anchoring collar 704 and the body 710 may position the anchoring collar 704 below a bottom surface of the countertop when the base 702 is positioned over the hole in the countertop. The offset between the anchoring collar 704 and the body 710 may be defined by the anchor surface 724 and the body 710 of the base 702 extending outward in opposite directions relative to the shaft 718 and the sleeve 720.

Referring to FIG. 10, the tubular shaft 718 may define the center passage 728 that is aligned with the bore 722 of the sleeve 720 relative to a longitudinal axis A1. The shaft 718 may also extend at least partially within the bore 722 of the sleeve 720. The shaft 718 can engage within the bore 722 of the sleeve 720 via the complementing anti-rotation shapes. The anti-rotational engagement of the shaft 718 in the bore 722 can limit or prevent relative rotation between the shaft 718 and the sleeve 720 about the longitudinal axis A1. The shaft 718 may also fit within the bore 722 of the sleeve 720 by near interference fit. Preferably, some clearance is provided between the shaft 718 and the sleeve 720 such that the sleeve 720 is movable relative to the shaft 718 in a direction of the longitudinal axis A1. Directional terms, such as “axial,” “radial,” “vertical,” “longitudinal,” “lateral,” “top,” “bottom,” “downward,” “upward,” and the like can be used to describe the top mount installation relative to the longitudinal axis A1, and are not limiting to any particular orientation of the top mount installation. Alternatively, the sleeve 720 may engage within the center passage 728 of the shaft 718 via complementing anti-rotation shapes and the sleeve may fit within the center passage by near interference fit.

The clamping bolt 706 can have a tail 730 that is received by and extends through the center passage 728 of the shaft 718 and the bore 722 of the sleeve 720 along the longitudinal axis A1. Each of the center passage 728 and the bore 722 can be sized to accommodate the tail 730 of the clamping bolt 706 and allow the clamping bolt 706 to rotate. A head 732 of the clamping bolt 706 may be seated at a top of the shaft 718. The head 732 may be sized and shaped such that the head 732 is stopped at the top of the shaft 718 and limited or prevented from being inserted in the center passage 728. The head 732 may also be accessible via the cut-out 714 in the body 710 of the base 702 to enable a user to manipulate the clamping bolt 706 using a screwdriver, wrench, or another suitable tool. Additionally or alternatively, the head 732 may be accessible and manipulate via the open top end of the base 702. For example, the user may manipulate the bolt 706 via the head 732 using a screwdriver with a hex insert.

The shaft 718 may extend downward from the base 702 a length L1, measured in a direction of the longitudinal axis A1. The length L1 is measured as a distance between a bottom of the pilot 716 and a bottom of the shaft 718. The shaft 718 may also include an additional length L2, measured in a direction of the longitudinal axis A1. The length L2 is measured as a distance between a top of the shaft 718 and the bottom of the pilot 716. A total length of the center passage 728 of the shaft 718 may be a sum of the lengths L1 and L2. An inner dimension, such as an inner diameter or inner cross-sectional area, of the center passage 728 may be substantially constant along the lengths L1 and L2. The inner dimension of the center passage 728 may be sized to accommodate the tail 730 of the clamping bolt 706 and allow rotation of the clamping bolt 706. An outer dimension, such as an outer perimeter or outer cross-sectional area, of the shaft 718 may also be substantially constant at least along the length L1. The outer dimension of the shaft 718 is sized to maintain anti-rotational engagement of the shaft 718 in the bore 722. The outer dimension of the shaft 718 may also be sized to enable movement of the sleeve 720 relative to the shaft 718 along the longitudinal axis A1.

The sleeve 720 has a length L3, measured in a direction of the longitudinal axis A1. The length L3 is measured as a distance between a top of the sleeve 720 and a bottom step 734 of the sleeve 720. An inner dimension of the sleeve 720, such as an inner perimeter or inner cross-sectional area of the bore 722, may be substantially constant along the length L3. The inner dimension of the sleeve 720 may be sized to accommodate the tail 730 and the shaft 718 in the bore 722. The inner dimension of the sleeve 720 along the length L3 may also be sized to maintain anti-rotational engagement of the shaft 718 in the bore 722. The inner dimension of the sleeve 720 may also be sized to enable movement of the sleeve 720 relative to the shaft 718 along the longitudinal axis A1. The bottom step 734 of the sleeve 720 may constrict or reduce the inner dimension of the sleeve 720 along a length L4. The length L4 is measured between a top of the bottom step 734 where the length L3 terminates and a bottom of the sleeve 720. The bottom step 734 may define a threaded hole 736 that extends the length L4 and enables threaded engagement between the tail 730 and the sleeve 720.

The length L3 may correspond to the length L1 of the shaft 718. For example, the length L3 and the length L1 may be approximately equal. Suitably, the length L3 and the length L1 can be sized to enable the sleeve 720 to move upward relative to the shaft 718. More particularly, the lengths L1, L3 can be sized to allow the sleeve 720 to move far enough along or relative to the shaft 718 to bring the anchoring collar 704 into contact with a bottom surface of the countertop while the base 702 is seated on and/or above the countertop. In other words, the lengths L1, L3 can be sized such that a distance between the anchoring surface 724 and the flange 708 can be reduced to a small enough size to create a secure and reliable clamp on the countertop. If the length L3 is too short or the length L1 is too long, the bottom step 734 can interfere with the shaft 718 during upward movement of the sleeve 720. Premature interference between the shaft 718 and the bottom step 734 can prevent a reliable clamp on the countertop between the anchoring collar 704 and the flange 708.

The tail 730 may be threaded to complement the threads within the threaded hole 736. The tail 730 has a length L5, measured in a direction of the longitudinal axis A1. The length L5 is measured as a distance between the head 732 of the clamping bolt 706 and a bottom of the tail 730. The length L5 may be approximately equal or greater than a sum of the lengths L1, L2, L3, and L4, such that the tail 730 can extend through the center passage 728, the bore 722, and the threaded hole 736. The length L5 may be long enough to enable the tail 730 to extend through the center passage 728, the bore 722, and the threaded hole 736 without the shaft 718 being received in the bore 722. Alternatively, the length L5 of the tail 730 may be shorter than a sum of the lengths L1, L2, L3, and L4. In such examples, the shaft 718 may be at least partially received by the sleeve 720 before the tail 730 can reach the threaded hole 736.

Still referring to FIG. 10, to assemble the top mount installation 700, the sleeve 720 can be positioned relative to the shaft 718 with the bore 722 aligned with the center passage 728 along the axis A1. The sleeve 720 can also be positioned with the anchoring collar 704 offset from the base 702 relative to the longitudinal axis A1. The clamping bolt 706 may be inserted in the bore 722 and the center passage 728, and the shaft 718 can be received by the sleeve 720, in either order. Alternatively, the clamping bolt 706 may be inserted in the bore 722 and the center passage 728, and the sleeve 720 can be received by the shaft 718, in either order. The tail 730 of the clamping bolt 706 can rotate in the bore 722 and the center passage 728 via a user manipulating the head 732 of the clamping bolt 706. The clamping bolt 706 can be tightened via threaded engagement between the tail 730 and the threaded hole 736. As the clamping bolt 706 is tightened, engagement between the threaded hole 736 and the threaded tail 730 may cause the sleeve 720 and the anchoring collar 704 to move upwards along or relative to the shaft 718 relative to the longitudinal axis A1 towards the base 702. Threaded engagement of the tail 730 within the hole 736 can translate rotation of the clamping bolt 706 to axial or vertical movement of the sleeve 720 along or relative to the shaft 718 via the anti-rotational engagement of the shaft 718 within the bore 722 or, alternatively, via anti-rotational engagement of the sleeve 720 within the center passage 728. This can eliminate the need for any additional tooling or other components to rotatably fix the sleeve 720 and anchoring collar 704 relative to the shaft 718 and/or base 702 and simplify the assembly and clamping process using the top mount installation 700.

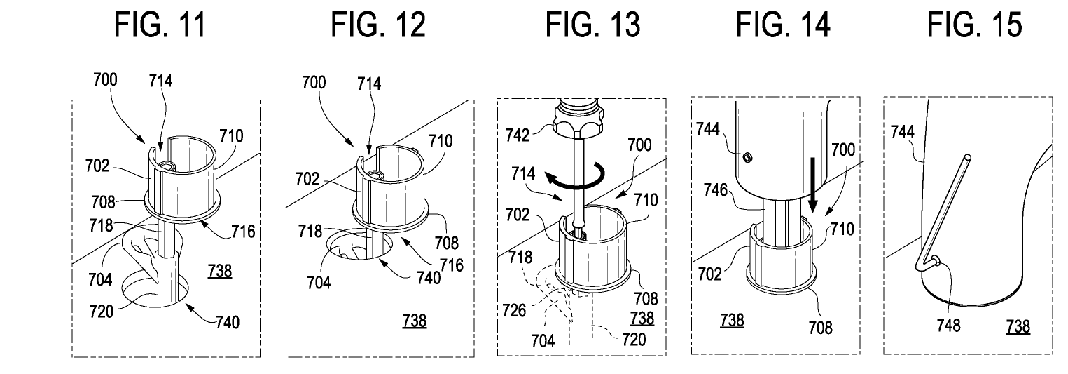

Referring to FIGS. 11-15, a sequence of installing the top mount installation 700 on a countertop 738 is shown. The assembled sleeve 720 and shaft 718 of the top mount installation 700 can be inserted through a hole 740 in the countertop 738. The anchoring collar 704 is also inserted through the hole 740 with the sleeve 720. The top mount installation 700 inserted in the hole 740 can move backward to position the anchoring collar 704 below the countertop 738. This positions the anchoring collar 704 such that the anchoring surface 724 faces a bottom surface of the countertop 738. Moving the top mount installation 700 backward also aligns the base 702 over the hole 740. The pilot 716 can fit within the hole 740 to locate the base 702 over the hole 740 and position the anchoring collar 704 behind the hole 740 and below the bottom surface. The flange 708 can then be seated on a top surface of the countertop 738 around the hole 740. A user can then access the clamping bolt 706 with a tool 742, such as a screwdriver or wrench, via the cut-out 714 in the body 710 of the base 702 and/or the open top end of the base to manipulate the clamping bolt 706. For example, the user may manipulate the bolt 706 via the head 732 using a screwdriver with a hex insert.

Rotation of the clamping bolt 706 using the tool 742 causes the anchoring collar 704 and the sleeve 720 to move upward towards the base 702 via threaded engagement of the clamping bolt 706 in the sleeve 720 as described above. The clamping bolt 706 may be tightened to bring the anchoring collar 704 to the clamping position in which the anchoring surface 724 contacts the bottom surface of the countertop 738. This creates a clamp between the anchoring surface 724 and the flange 708 on the countertop 738. With the top mount installation 700 secured or clamped on the countertop 738 a spout and/or a handle 744 of a faucet can be connected to the base 702. Water conduits, hoses, or tubes 746 can be installed through the base 702 and the hole 740 in the countertop 738 to connect the faucet with a water supply. The spout and/or handle 744 can be secured to the base 702 via a set screw 748, or another suitable retainer such as a key or another fastener.

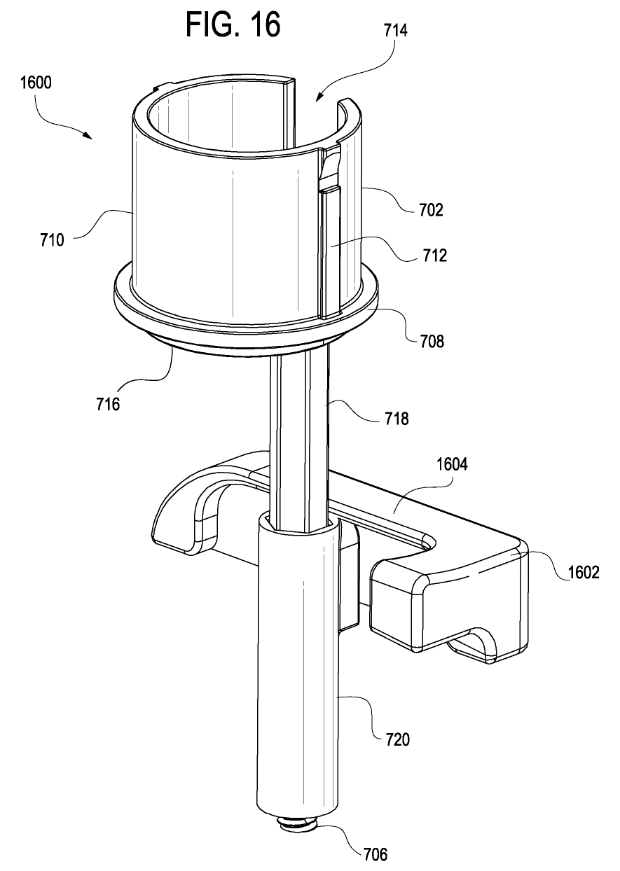

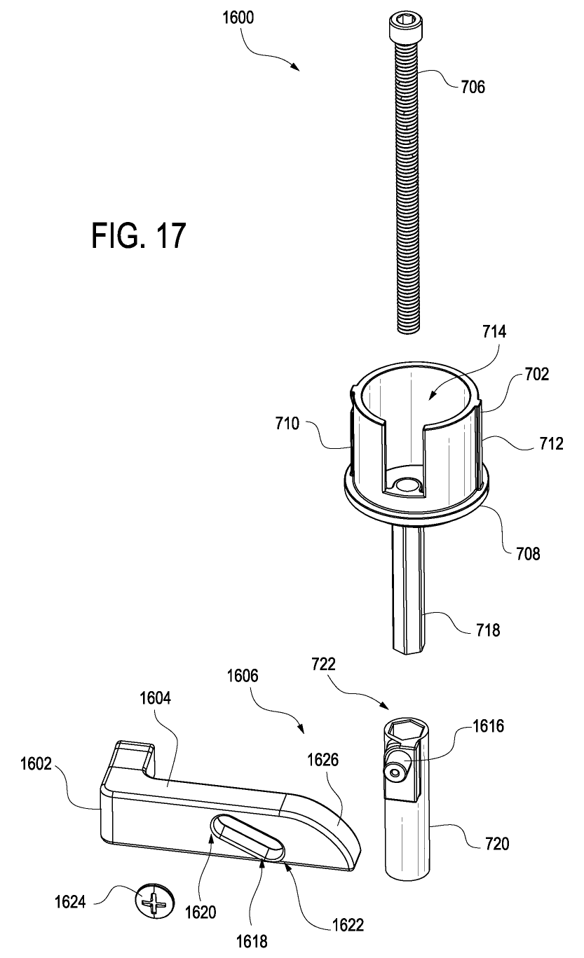

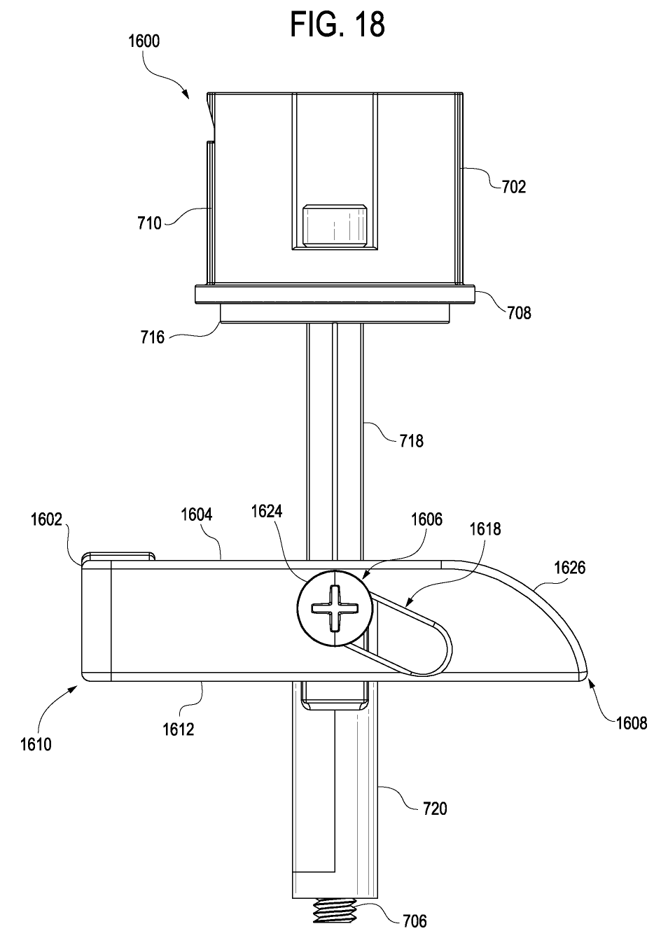

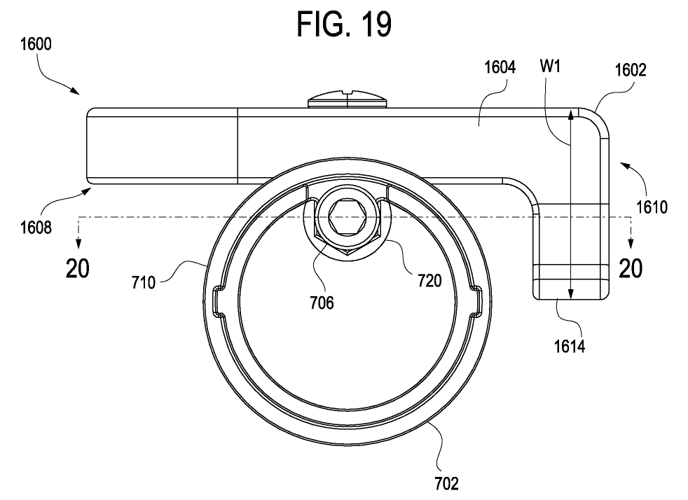

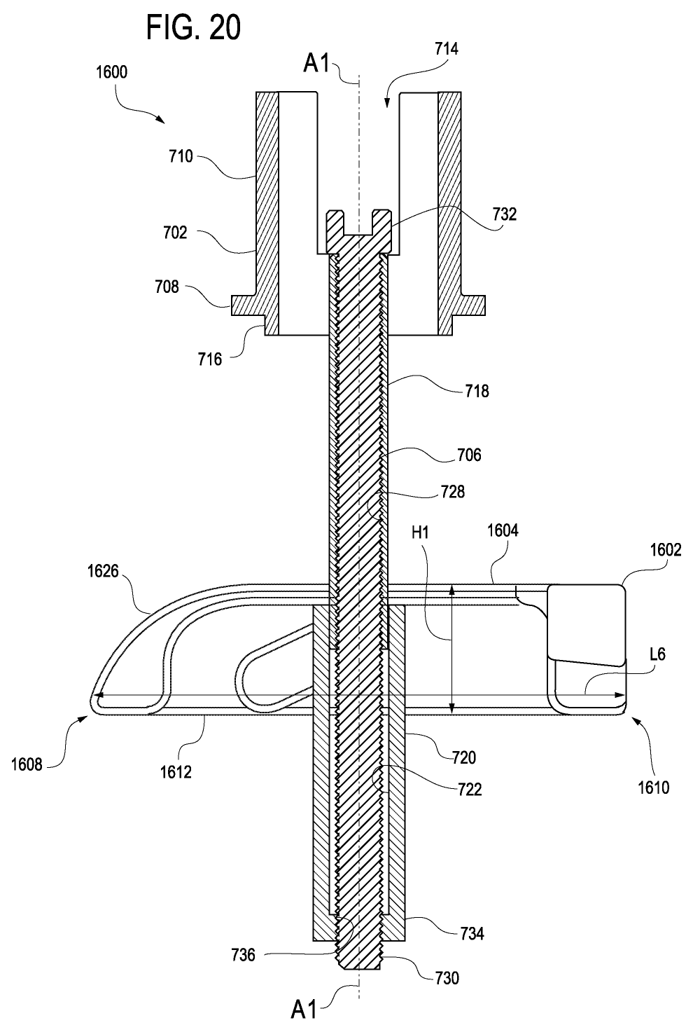

Turning now to FIGS. 16 and 17, another example of a top mount installation that can be used to mount a fixture on a structure is shown isolated and indicated generally at 1600. The top mount installation 1600 can be used to mount any one of the faucets 100, 200, 300, 500 on the countertop 102, 202, 302, 502. Additional views of the top mount installation 1600 are provided in FIGS. 18-20. The top mount installation 1600 of this example may include similar elements and components as the top mount installation 700 of FIGS. 7-10. Like reference numbers are used to indicate like parts. For brevity and conciseness, differences between the top mount installation 1600 and the top mount installation 700 may be described. Similarities between the top mount installation 1600 and the top mount installation 700 can be recognized from FIGS. 7-26. Elements and components of the top mount installation 700 that are not labeled or explicitly described for the top mount installation 1600 are not necessarily excluded. The top mount installation 1600 can include any element or component of the top mount installation 700, and vice versa, unless expressly stated otherwise or the context clearly indicates otherwise.

The top mount installation 1600 includes the base 702 and an anchor that is movable relative to the base 702 between a clamping position and a non-clamping position. The anchor may include an anchoring arm 1602 in this example. The top mount installation 1600 may include more than one anchoring arm 1602, such as two anchoring arms 1602. The anchoring arm 1602 is coupled to the sleeve 720 and can move with the sleeve 720 relative to the shaft 718 towards the base 702. As described above, the sleeve 720 and the anchoring arm 1602 can move relative to the base 702 via a user manipulating the clamping bolt 706. The anchoring arm 1602 includes an anchoring surface 1604 that may contact the bottom of the countertop when the anchoring arm 1602 is in the clamping position.

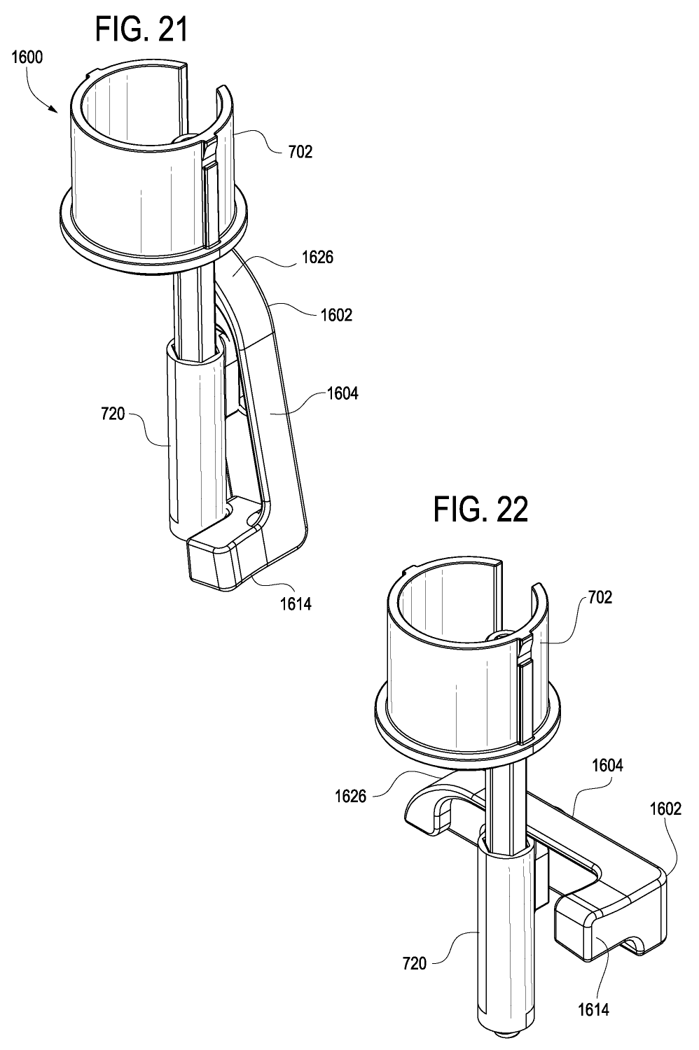

The anchoring arm 1602 is also rotatable or pivotable relative to the sleeve 720 between a first orientation, here a horizontal orientation, and a second orientation, here a vertical orientation. Movement of the anchoring arm 1602 between the horizontal orientation and the vertical orientation is described below with reference to FIGS. 21-24. The horizontal orientation of the anchoring arm 1602 may correspond to the clamping position of the anchoring arm 1602. In the horizontal orientation, the anchoring surface 1604 of the anchoring arm 1602 faces upward towards the base 702 for contacting the bottom of the countertop. Additionally, in the horizontal orientation, the anchoring arm 1602 can limit or prevent upward movement of the top mount installation 1600 through the hole in the countertop. Additionally, in the horizontal orientation, the anchoring arm 1602 extends generally perpendicular to the longitudinal axis A1 between a first end 1608 and a second end 1610. In the horizontal orientation, the first end 1608 and the second end 1610 are each positioned outward beyond the base 702 and the anchoring arm 1602 forms a T-shape profile with the sleeve 720.

The anchoring arm 1602 has a length L6 measured between the first end 1608 and the second end 1610. The length L6 can be sized to provide sufficient contact between the anchoring surface 1604 and the bottom surface of the countertop for providing a reliable clamp with the flange 708 of the base 702. The anchoring arm 1602 can also include a structural block 1614. The structural block 1614 can be positioned at the first end 1608 and/or the second end 1610. The structural block 1614 projects outward at the first end 1608 and/or the second end 1610 and generally orthogonal to the length L6. The structural block 1614 may provide additional surface area contact between the anchoring surface 1604 and the bottom surface of the countertop in the direction orthogonal to the length L6. The structural block 1614 can thereby enable a more reliable clamp between the anchoring arm 1602 and the flange 708.

The length L6 of the anchoring arm 1602 may limit or prevent the anchoring arm 1602 from being inserted through the hole in the countertop in the horizontal orientation. The anchoring arm 1602 can rotate or pivot to the vertical orientation to enable the anchoring arm 1602 to be inserted through the hole in the countertop. The anchoring arm 1602 is dimensioned to enable insertion through the hole in the countertop in the vertical orientation. The anchoring arm 1602 has a height H1 measured between the anchoring surface 1604 and a bottom surface 1612. The height H1 is smaller than an inner dimension, such as an inner diameter, of the hole in the countertop. The structural block 1614 can also project outward from the first end 1608 and/or the second end 1610 a width W1. The width W1 is smaller than the inner dimension of the hole in the countertop.

The top mount installation 1600 in this example includes a cam mechanism 1606. The cam mechanism 1606 enables the anchoring arm 1602 to rotate or pivot between the horizontal orientation and the vertical orientation. The cam mechanism 1606 includes a cam shaft 1616 projecting from the sleeve 720 and a cam slot 1618 defined in the anchoring arm 1602. The cam shaft 1616 is received in the cam slot 1618. The cam slot 1618 enables the anchoring arm 1602 to rotate or pivot about the cam shaft 1616. The cam slot 1618 is angled between a first slot end 1620 proximate the anchoring surface 1604 and a second slot end 1622 proximate the bottom surface 1612. When the anchoring arm 1602 moves towards the horizontal orientation, the cam shaft 1616 is guided in the cam slot 1618 toward the first slot end 1620. When the anchoring arm 1602 moves towards the vertical orientation, the cam shaft 1616 is guided in the cam slot 1618 toward the second slot end 1622. The anchoring arm 1602 may also be secured on the cam shaft 1616 via a screwhead bolt 1624 or another suitable fastener that maintains the cam shaft 1616 within the cam slot 1618.

The first slot end 1620 of the cam slot 1618 may be positioned generally in a middle of the arm 1602 between the first end 1608 and the second end 1610. The second slot end 1622 of the cam slot 1618 may be offset from the middle towards the first end 1608 of the arm 1602. The structural block 1614 may be positioned at the second end 1610 of the anchoring arm 1602 and may add weight to the anchoring arm 1602 at the second end 1610. The additional weight from the structural block at the second end 1610 may bias the anchoring arm 1602 toward the vertical orientation. The second end 1610 of the anchoring arm faces downward in the vertical orientation. More particularly, the additional weight at the second end 1610 may naturally guide the cam shaft 1616 towards the second slot end 1622 in the cam slot 1618 and cause the anchoring arm 1602 to pivot or rotate toward the vertical orientation. The anchoring arm 1602 can then move to the horizontal orientation by guiding the cam shaft 1616 towards the first slot end 1620 in the cam slot 1618.

The first end 1608 of the anchoring arm 1602 may have a contoured or curved surface 1626. The curved surface 1626 transitions from the anchoring surface 1604. The curved surface 1626 gradually reduces the height H1 of the anchoring arm 1602 from the anchoring surface 1604 towards the first end 1608. The curved surface 1626 faces upward when the anchoring arm 1602 is in the vertical orientation. The curved surface 1626 engages with the bottom surface of the countertop when the anchoring arm 1602 is moved upwards towards the bottom surface of the countertop to the clamping position. The engagement between the curved surface and the bottom surface of the countertop guides the cam shaft 1616 towards the first slot end 1620 in the cam slot 1618. This causes the anchoring arm 1602 to pivot or rotate toward the horizontal orientation.

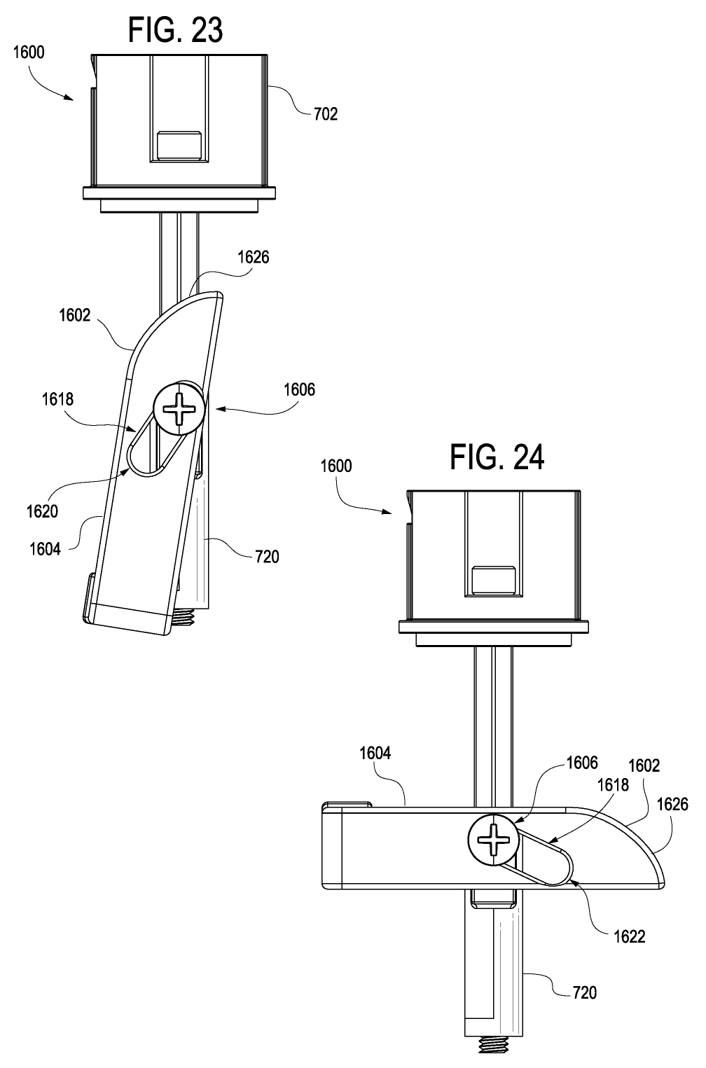

FIGS. 21 and 22 depict a sequence of the anchoring arm 1602 moving from the vertical orientation in FIG. 21 towards the horizontal orientation in FIG. 22. FIGS. 23 and 24 also depict the sequence from different views, with FIG. 23 showing the anchoring arm 1602 in the vertical orientation and FIG. 24 showing the anchoring arm 1602 in the horizontal orientation. The anchoring arm 1602 may be biased towards the vertical orientation via gravity and the weight of the structural block 1614. The anchoring arm 1602 may be laterally offset from the base 702 such that the anchoring surface 1604 and the curved surface 1626 project radially outward beyond the base 702. The curved surface 1626 may face upwards in the vertical orientation for engaging a bottom surface of the countertop. The structural block 1614 may engage the sleeve 720 in the vertical orientation to limit rotation of the anchoring arm 1602. Alternatively, where the sleeve 720 is received by the shaft 718, the structural block 1614 may engage the shaft. Engagement between the block 1614 and the sleeve 720, or between the block and the shaft 718, may align the curved surface 1626 in the vertical orientation for engagement with the bottom surface of the countertop. As the anchoring arm 1602 moves towards the horizontal orientation, e.g., via engagement between the curved surface 1626 and the bottom surface of the countertop, the anchoring surface 1604 gradually faces upwards and can engage the bottom surface of the countertop.

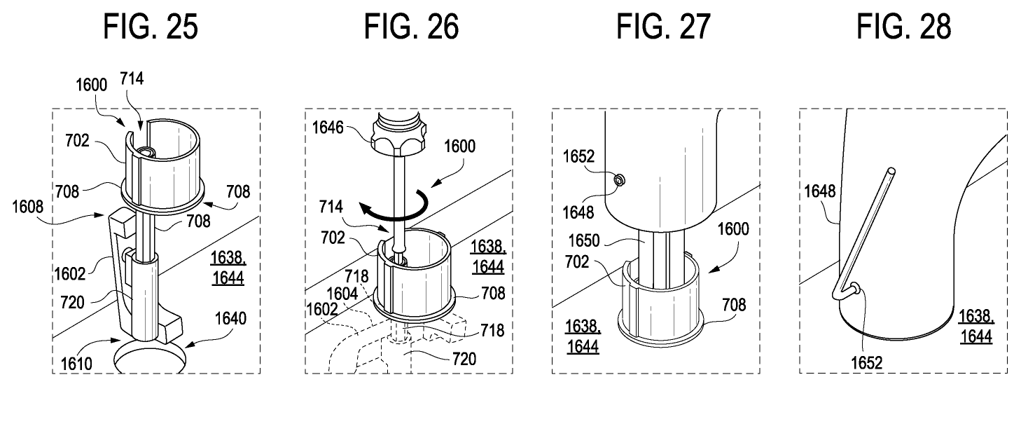

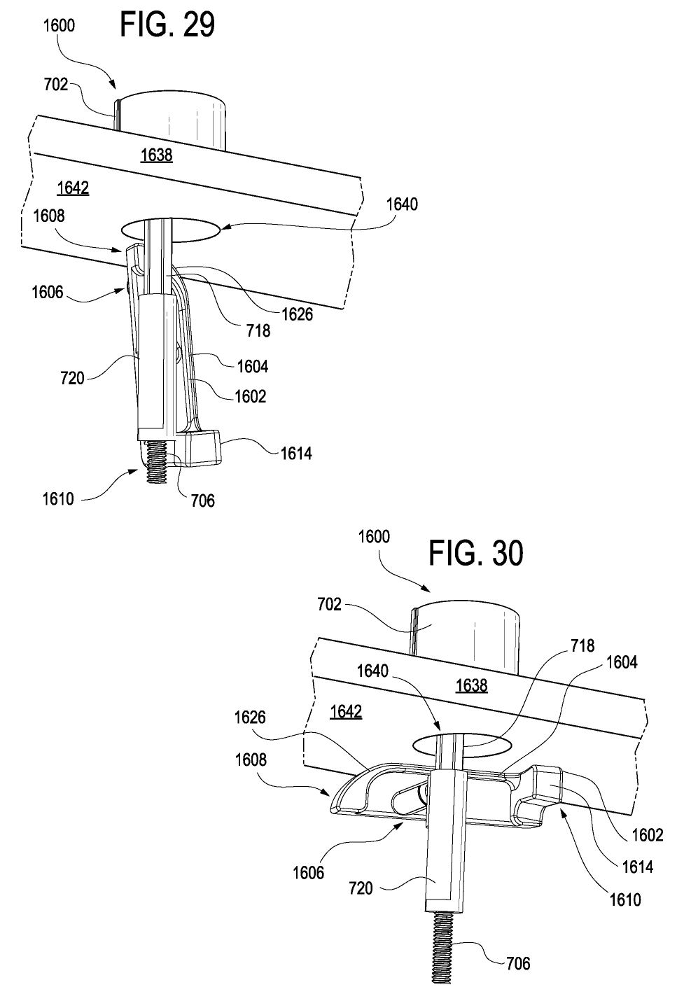

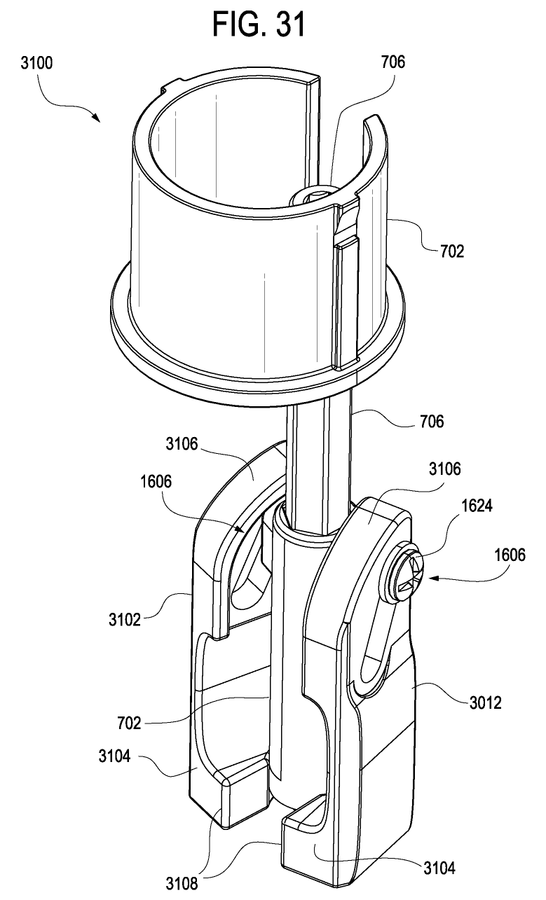

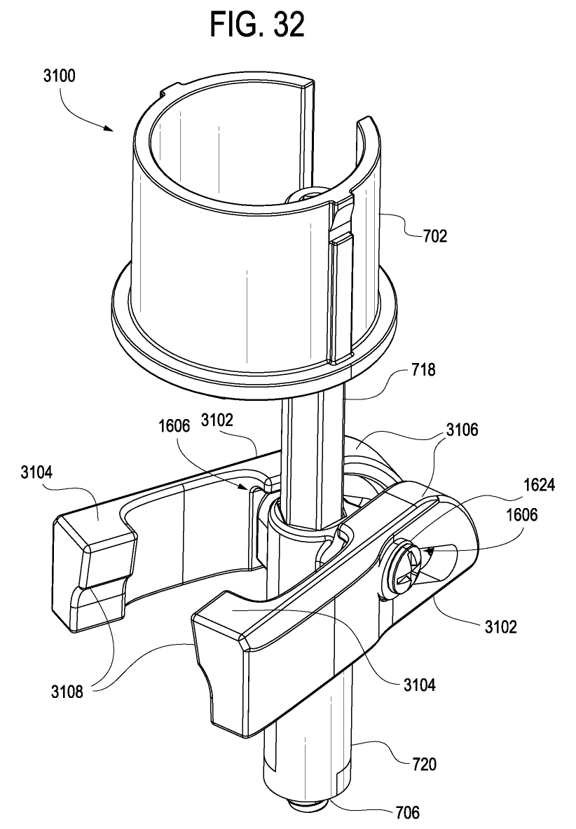

Referring to FIGS. 25-28 and FIGS. 29 and 30, a sequence of installing the top mount installation 1600 on a countertop 1638 is shown. The assembled sleeve 720, shaft 718, and anchoring arm 1602 of the top mount installation 1600 can be inserted through a hole 1640 in the countertop 1638. The anchoring arm 1602 is in the vertical orientation when inserted through the hole 1640, with the first end 1608 facing upward and the second end 1610 facing downward. When the anchoring arm 1602 is inserted through the hole 1640, the curved surface 1626 of the anchoring arm 1602 can be positioned to face a second surface, here a bottom surface 1642, of the countertop 1638. Positioning the top mount installation 1600 also aligns the base 702 over the hole 1640 with the flange 708 seated on a first surface, here a top surface 1644, of the countertop 1638 around the hole 1640. The pilot 716 can fit within the hole 1640 to locate the base 702 over the hole 1640 and position the anchoring arm 1602 behind the hole 1640 and below the bottom surface 1642. A user can then access the clamping bolt 706 with a tool 1646, such as a screwdriver or wrench, via the cut-out 714 in the base 702 and/or the open top end of the base to manipulate the clamping bolt 706. For example, the tool 1646 may include a screwdriver with a hex insert.

Rotation of the clamping bolt 706 using the tool 1646 causes the sleeve 720 to move upward towards the base 702 via threaded engagement of the clamping bolt 706 in the sleeve 720 as described above. The anchoring arm 1602 coupled to the sleeve 720 is also moved upward towards the clamping position. This brings the curved surface 1626 into contact with the bottom surface 1642 of the countertop 1638. The clamping bolt 706 may be tightened to move the anchoring arm 1602 to the horizontal orientation, via engagement between the curved surface 1626 and the bottom surface 1642 and rotation or pivoting of the anchoring arm 1602 via the cam mechanism 1606. The anchoring surface 1604 is gradually brought into engagement with the bottom surface 1642 in the clamping position of the anchoring arm 1602. Contact between the anchoring surface 1604 and the bottom surface 1642 can create a clamp between the anchoring surface 1604 and the flange 708 on the top surface 1644 of the countertop 1638. With the top mount installation 1600 secured or clamped on the countertop 1638 a spout and/or a handle 1648 of a faucet can be connected to the base 702. Water conduits, hoses, or tubes 1650 can be installed through the base 702 and the hole 1640 in the countertop 1638 to connect the faucet with a water supply. The spout and/or handle 1648 can be secured to the base 702 via a set screw 1652, or another suitable retainer such as a key or another fastener.

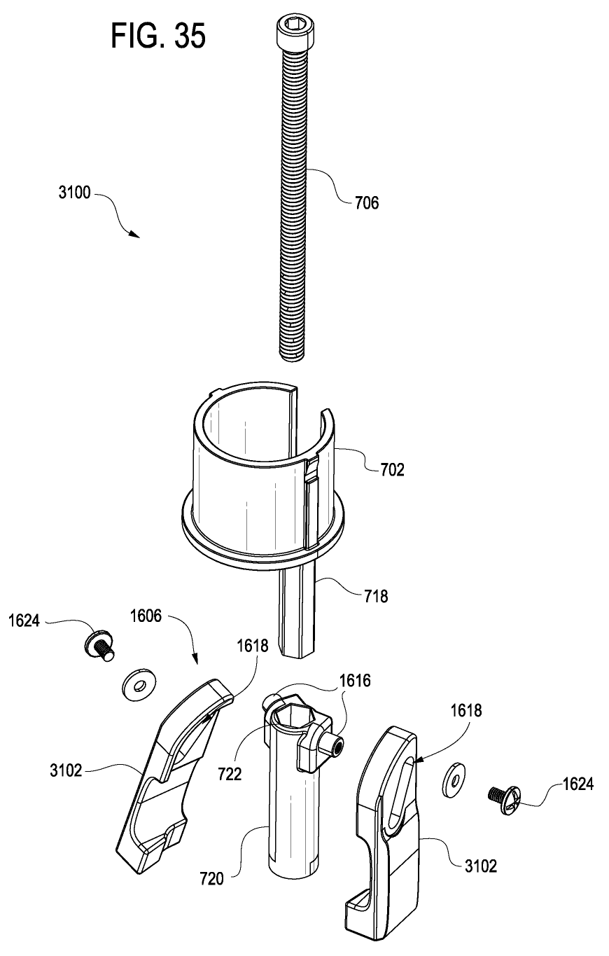

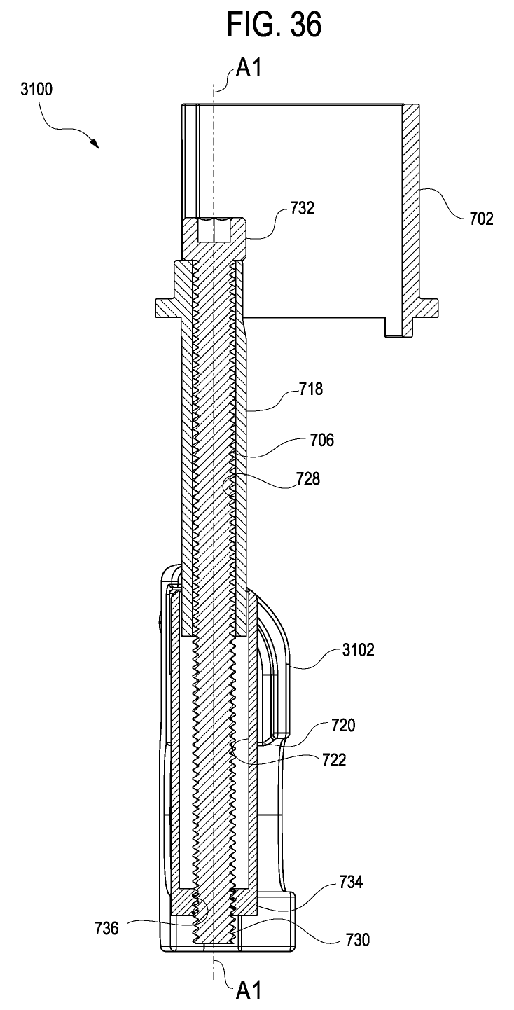

Turning now to FIG. 31, another example of a top mount installation that can be used to mount a fixture on a structure is shown isolated and indicated generally at 3100. The top mount installation 3100 can be used to mount any one of the faucets 100, 200, 300, 500 on the countertop 102, 202, 302, 502. Additional views of the top mount installation 3100 are provided in FIGS. 32-36. The top mount installation 3100 of this example may include similar elements and components as the top mount installations 700, 1600 described above. Like reference numbers are used to indicate like parts. For brevity and conciseness, differences between the top mount installation 3100 and the top mount installations 700, 1600 may be described. Similarities between the top mount installation 3100 and the top mount installations 700, 1600 can be recognized from FIGS. 7-36. Elements and components of the top mount installations 700, 1600 that are not labeled or explicitly described for the top mount installation 3100 are not necessarily excluded. The top mount installation 3100 can include any element or component of the top mount installation 700 and/or the top mount installation 1600, and vice versa, unless expressly stated otherwise or the context clearly indicates otherwise.

The top mount installation 3100 includes the base 702 and an anchor that is movable relative to the base 702 between a clamping position and a non-clamping position. The anchor may include two anchoring arms 3102 in this example. The anchoring arms 3102 may each be similar to the anchoring arm 1602 described above. Each anchoring arm 3102 includes an anchoring surface 3104, a curved surface 3106 transitioning from the anchoring surface 3104, and a structural block 3108 opposite the curved surface 3106. Each anchoring arm 3102 is coupled to the sleeve 720. For example, each anchoring arm 3102 may be coupled to the sleeve 720 via the screwhead bolt 1624 of the respective cam mechanism 1606 or another suitable fastener. Each anchoring arm 3102 can move with the sleeve 720 along or relative to the shaft 718 towards the base 702. As described above, the sleeve 720 and the anchoring arms 3102 can move relative to the base 702 via a user manipulating the clamping bolt 706. The anchoring surfaces 3104 may contact the bottom of the countertop when the anchoring arms 3102 are in the clamping position.

The anchoring arms 3102 are also rotatable or pivotable relative to the sleeve 720 between the first orientation, here again the horizontal orientation, and the second orientation, here the vertical orientation. Rotation or pivoting of the anchoring arms 3102 may be facilitated via respective cam mechanisms 1606, which operate similar to the cam mechanism 1606 described above for the anchoring arm 1602.

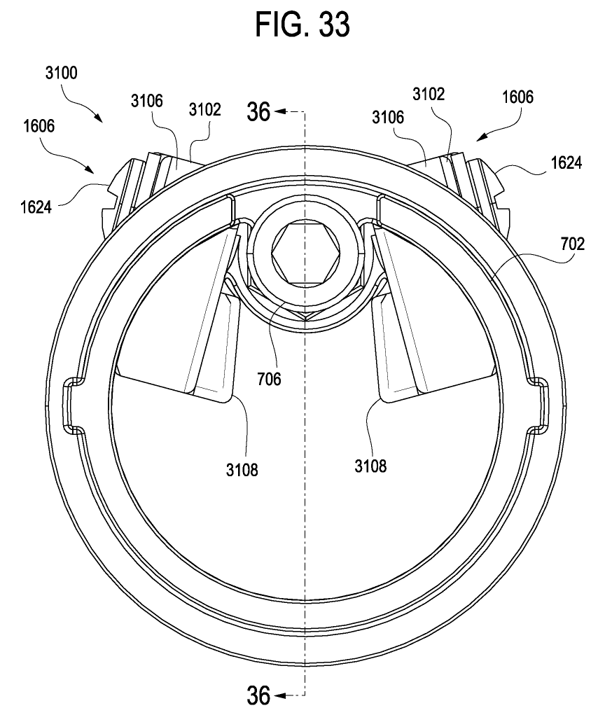

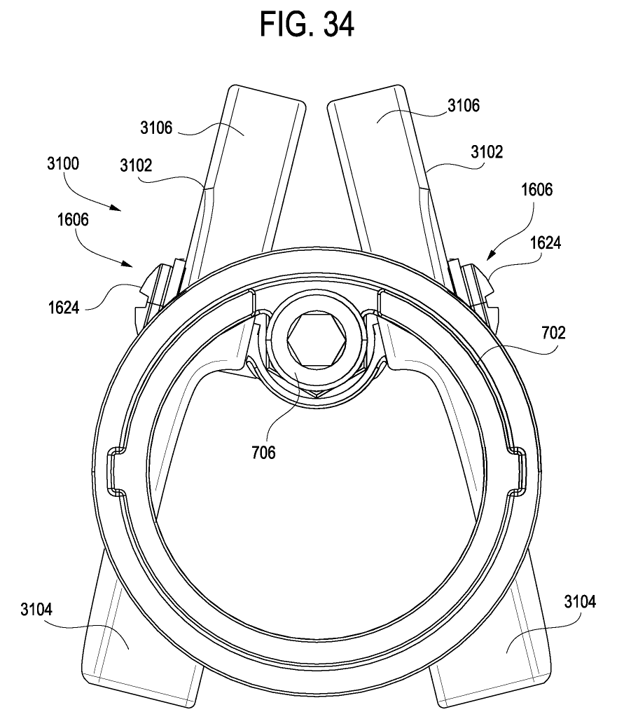

FIGS. 31 and 32 depict a sequence of the anchoring arms 3102 moving from the vertical orientation in FIG. 31 towards the horizontal orientation in FIG. 32. FIGS. 33 and 34 also depict the sequence from different views, with FIG. 33 showing the anchoring arms 3102 in the vertical orientation and FIG. 34 showing the anchoring arms 3102 in the horizontal orientation. The anchoring arms 3102 may be biased towards the vertical orientation via gravity and the weight of the structural blocks 3108. The anchoring arms 3102 may be laterally offset from the base 702 such that the anchoring surfaces 3104 and the curved surfaces 3106 project radially outward beyond the base 702. The curved surfaces 3106 may face upwards in the vertical orientation for engaging a bottom surface of the countertop. The structural blocks 3108 may engage the sleeve 720 in the vertical orientation to limit rotation of the anchoring arms 3102. Alternatively, where the sleeve 720 is received by the shaft 718, the structural block 3108 may engage the shaft. Engagement between the blocks 3108 and the sleeve 720, or between the blocks and the shaft 718, may align the curved surfaces 3106 in the vertical orientation for engagement with the bottom surface of the countertop. As the anchoring arms 3102 move towards the horizontal orientation, e.g., via engagement between the curved surfaces 3106 and the bottom surface of the countertop, the anchoring surfaces 3104 gradually face upwards and can engage the bottom surface of the countertop.

Referring to FIGS. 33 and 34, the anchoring arms 3102 may be arranged in a V-shape. In the vertical orientation of FIG. 33, the anchoring arms 3102 in the V-shape formation may be dimensioned to fit through the hole in the countertop. In the horizontal orientation of FIG. 34, the anchoring arms 3102 in the V-shape formation may allow clearance through the open ends of the base 702 for hoses, conduits, tubes, or other connections installed through the base 702 and the countertop.

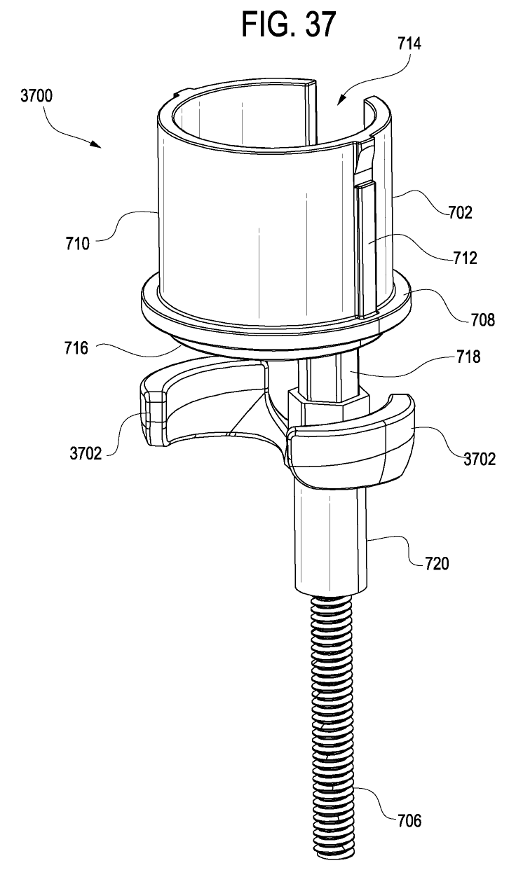

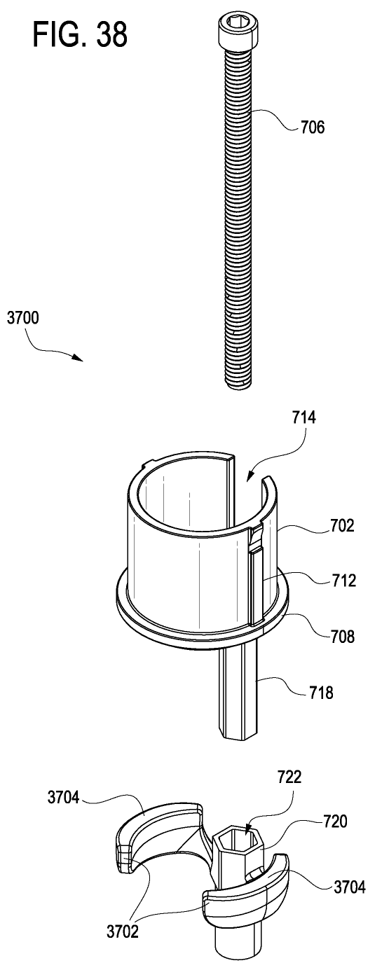

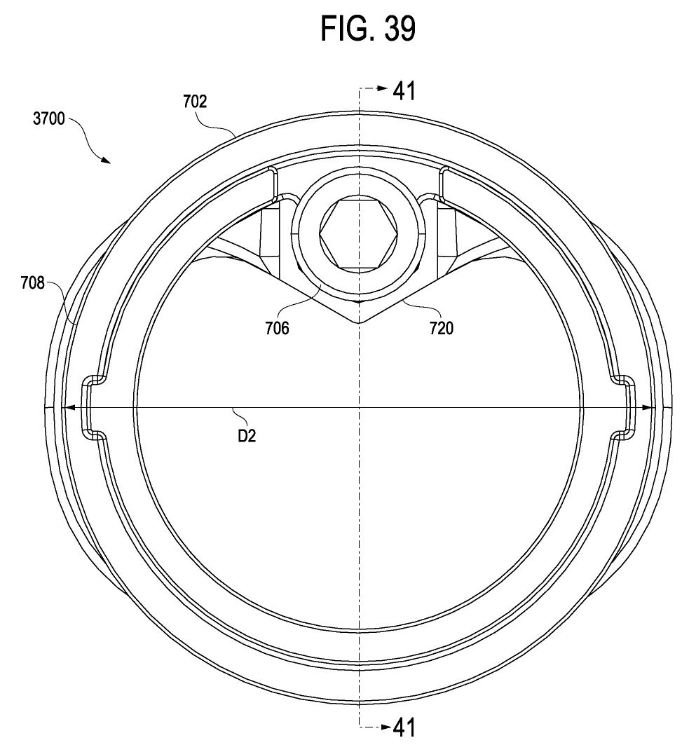

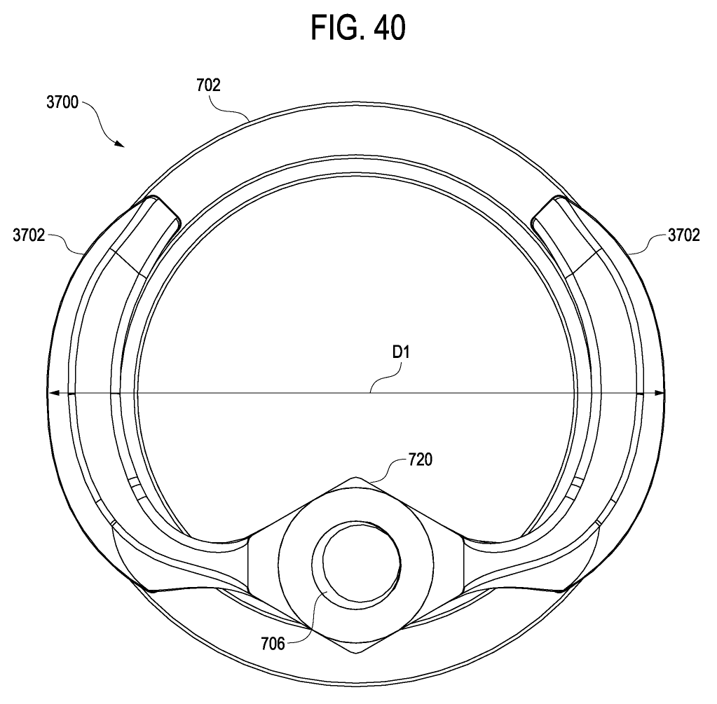

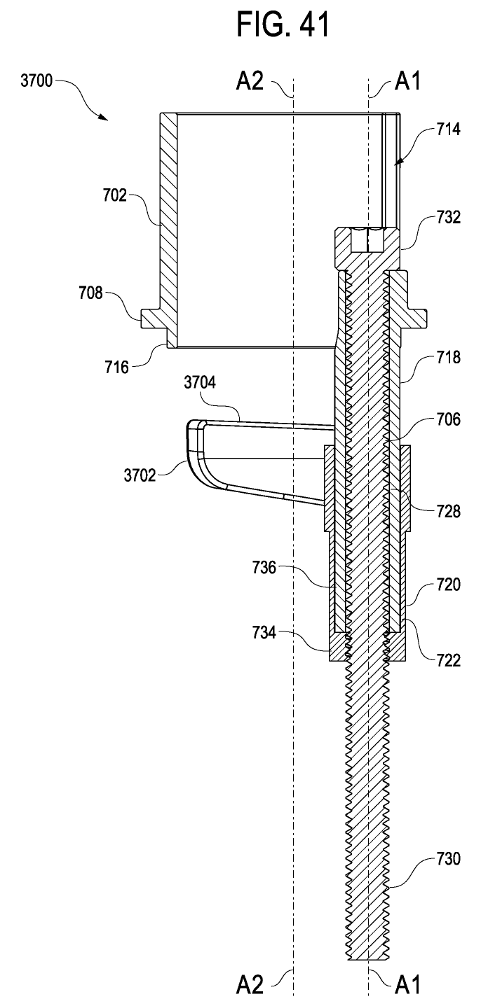

Turning now to FIGS. 37 and 38, another example of a top mount installation that can be used to mount a fixture on a structure is shown isolated and indicated generally at 3700. The top mount installation 3700 can be used to mount any one of the faucets 100, 200, 300, 500 on the countertop 102, 202, 302, 502. Additional views of the top mount installation 3700 are provided in FIGS. 39-41. The top mount installation 3700 of this example may include similar elements and components as the top mount installations 700, 1600, and/or 3100. Like reference numbers are used to indicate like parts. For brevity and conciseness, differences between the top mount installation 3700 and the top mount installations 700, 1600, 3100 may be described. Similarities between the top mount installation 3700 and the top mount installations 700, 1600, 3100 can be recognized from FIGS. 7-41. Elements and components of the top mount installations 700, 1600, 3100 that are not labeled or explicitly described for the top mount installation 3700 are not necessarily excluded. The top mount installation 3700 can include any element or component of the top mount installations 700, 1600, and/or 3100, and vice versa, unless expressly stated otherwise or the context clearly indicates otherwise.

The top mount installation 3700 includes the base 702 and an anchor that is movable relative to the base 702 between a clamping position and a non-clamping position. The anchor may include anchoring wings 3702 in this example. The top mount installation 3700 may include one anchoring wing 3702 or more than one anchoring wing 3702, such as two anchoring wings 3702. Each anchoring wing 3702 is joined to the sleeve 720. The anchoring wings 3702 can move with the sleeve 720 along or relative to the shaft 718 towards the base 702 via a user manipulating the clamping bolt 706 from a convenient location, e.g., above a countertop, as described above. The anchoring wings 3702 may be coupled to the sleeve 720 or may be made integral with the sleeve 720 as a one-piece unit. Each anchoring wing 3702 includes an anchoring surface 3704 that contacts the bottom of the countertop when the anchoring wing 3702 is in the clamping position.

The anchoring wings 3702 project outward from the sleeve 720 and extend in an arcuate manner below the base 702. The anchoring wings 3702 are generally concentrically aligned with the base 702 relative to an axis A2 that is parallel to the longitudinal axis A1. The anchoring wings 3702 define an outer dimension D1, such as an outer diameter and the flange 708 of the base 702 defines an outer dimension D2, such as an outer diameter. The outer dimension D1 may be approximately equal to or greater than the outer dimension D2. The outer dimension D1 of the anchoring wings 3702 can be sized to position the anchoring wings 3702 below a bottom surface of a countertop when inserted into a hole in the countertop. In other words, the outer dimension D1 is sized to enable the anchoring surfaces 3704 to contact the bottom surface of the countertop. The anchoring wings 3702 are also positioned below the bottom surface when the base 702 is positioned over the hole in the countertop.

The anchoring wings 3702 are also pliable or flexible to enable the anchoring wings 3702 to be inserted into the hole in the countertop. More particularly, the anchoring wings 3702 can flex inwardly when inserted through the hole in the countertop. The anchoring wings 3702 can also resume the outer dimension D1 once below the countertop. The anchoring wings 3702 can be made of a suitable elastomeric or memory-shape material that enables the anchoring wings 3702 to function as described. Once inserted into the hole on the countertop, the anchoring wings 3702 can move upward via a user manipulating the clamping bolt 706 as described above. The clamping bolt 706 can be tightened until the anchoring surfaces 3704 are brought into sufficient contact with the bottom surface of the countertop to create a clamp between the anchoring surfaces 3704 and the flange 708.

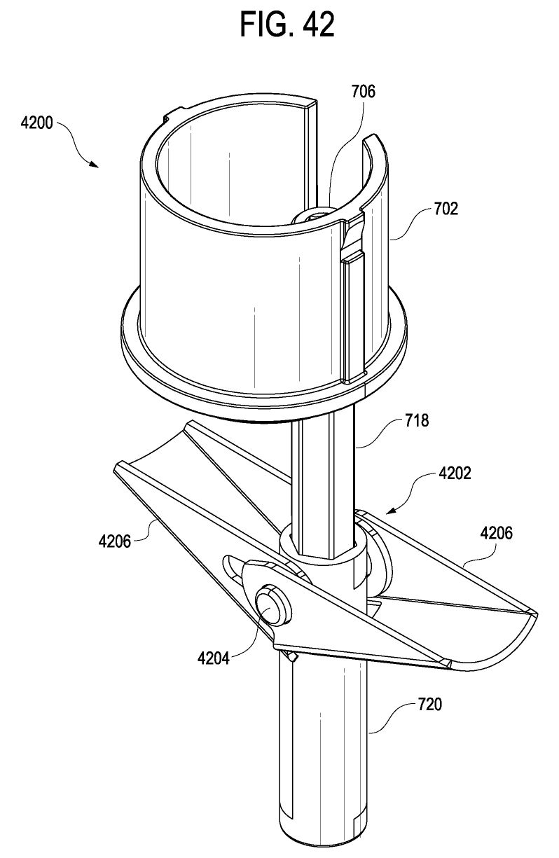

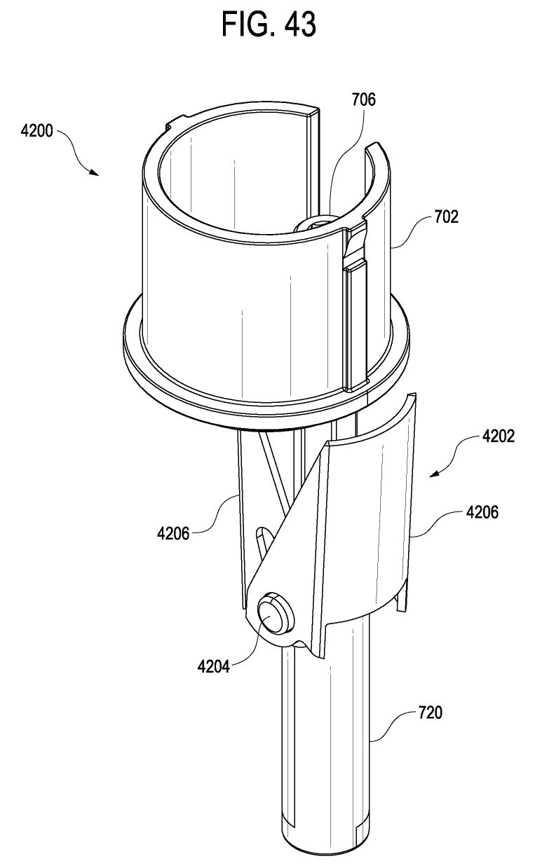

Turning now to FIG. 42, another example of a top mount installation that can be used to mount a fixture on a structure is shown isolated and indicated generally at 4200. The top mount installation 4200 can be used to mount any one of the faucets 100, 200, 300, 500 on the countertop 102, 202, 302, 502. Additional views of the top mount installation 4200 are provided in FIGS. 43-47. The top mount installation 4200 of this example may include similar elements and components as the top mount installations 700, 1600, 3100, and/or 3700. Like reference numbers are used to indicate like parts. For brevity and conciseness, differences between the top mount installation 4200 and the top mount installations 700, 1600, 3100, 3700 may be described. Similarities between the top mount installation 4200 and the top mount installations 700, 1600, 3100, 3700 can be recognized from FIGS. 7-47. Elements and components of the top mount installations 700, 1600, 3100, 3700 that are not labeled or explicitly described for the top mount installation 4200 are not necessarily excluded. The top mount installation 4200 can include any element or component of the top mount installations 700, 1600, 3100, and/or 3700, and vice versa, unless expressly stated otherwise or the context clearly indicates otherwise.

The top mount installation 4200 includes the base 702 and an anchor that is movable relative to the base 702 between a clamping position and a non-clamping position. The anchor in this example may include a butterfly anchor 4202. The butterfly anchor 4202 is coupled to the sleeve 720. For example, the butterfly anchor 4202 may be coupled to the sleeve 720 via a pair of shafts 4204 extending outwardly from the sleeve 720. A retainer, such as a nut or a bolthead, may be included to retain the butterfly anchor 4202 on the shafts 4204. The butterfly anchor 4202 can move with the sleeve 720 along or relative to the shaft 718 towards the base 702. As described above, the sleeve 720 and the butterfly anchor 4202 can move relative to the base 702 via a user manipulating the clamping bolt 706.

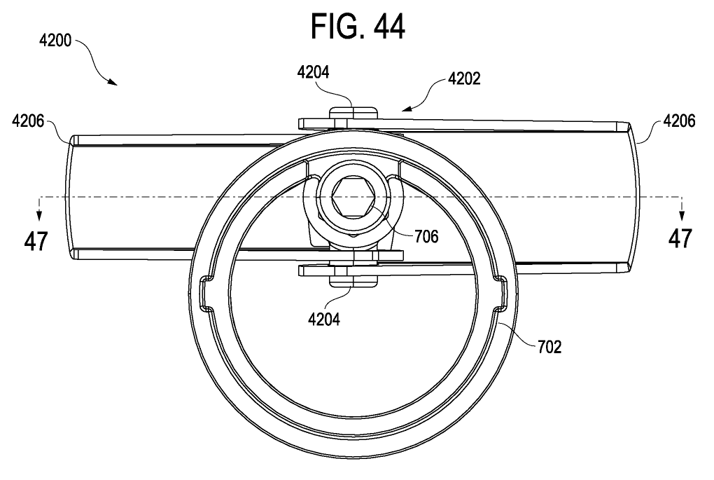

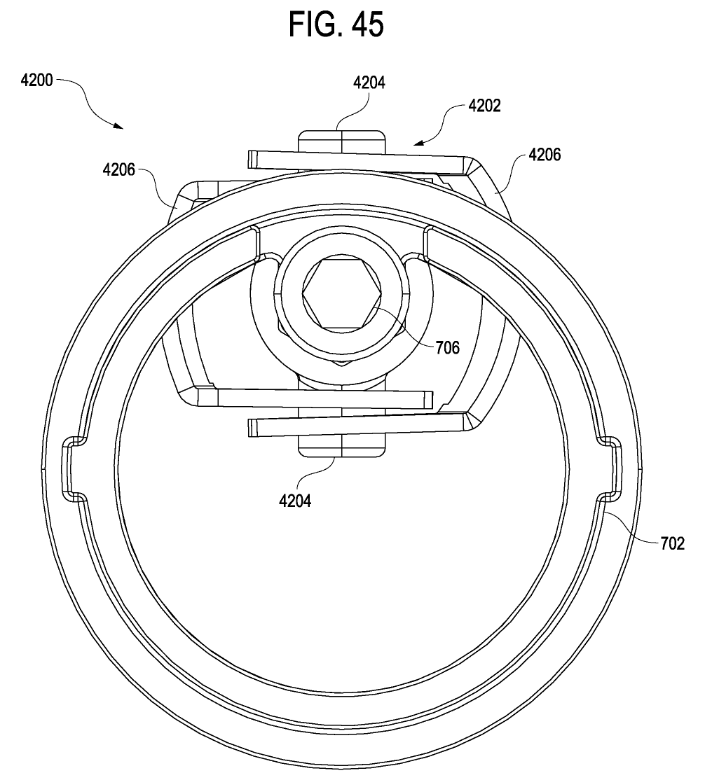

The butterfly anchor 4202 may include wings 4206 that can each contact the bottom of the countertop when the wings are in a first orientation, here an open or horizontal orientation. Each wing 4206 may pivot or rotate about the shafts 4204 between the open orientation and a second orientation, here a closed or vertical orientation. The wings 4206 in the closed orientation may be insertable through a hole in a countertop. FIGS. 42 and 43 depict a sequence of the butterfly anchor 4202 moving from the open orientation in FIG. 42 towards the closed orientation in FIG. 43. FIGS. 44 and 45 also depict the sequence from different views, with FIG. 44 showing the butterfly anchor 4202 in the open orientation and FIG. 45 showing the butterfly anchor 4202 in the closed orientation.

The butterfly anchor 4202 may be biased towards the open orientation via gravity and the weight of the wings 4206. In some embodiments, the butterfly anchor 4202 may be biased towards the open orientation via a spring mechanism that urges the wings 4206 outwards and open. The butterfly anchor 4202 may be moved towards the closed orientation when inserted through a hole in the countertop. For example, the butterfly anchor 4202 may be closed via an inward force exerted on the wings 4206 via an edge of the hole and/or via a user pressing the wings 4206 inwardly. In examples where the butterfly anchor 4202 includes the spring mechanism, the spring may compress in response to the inward force exerted on the wings 4206 to temporarily allow the butterfly anchor 4206 to close. The spring mechanism may cause the butterfly anchor 4206 to resume the open orientation when the inward force is released from the wings 4206.

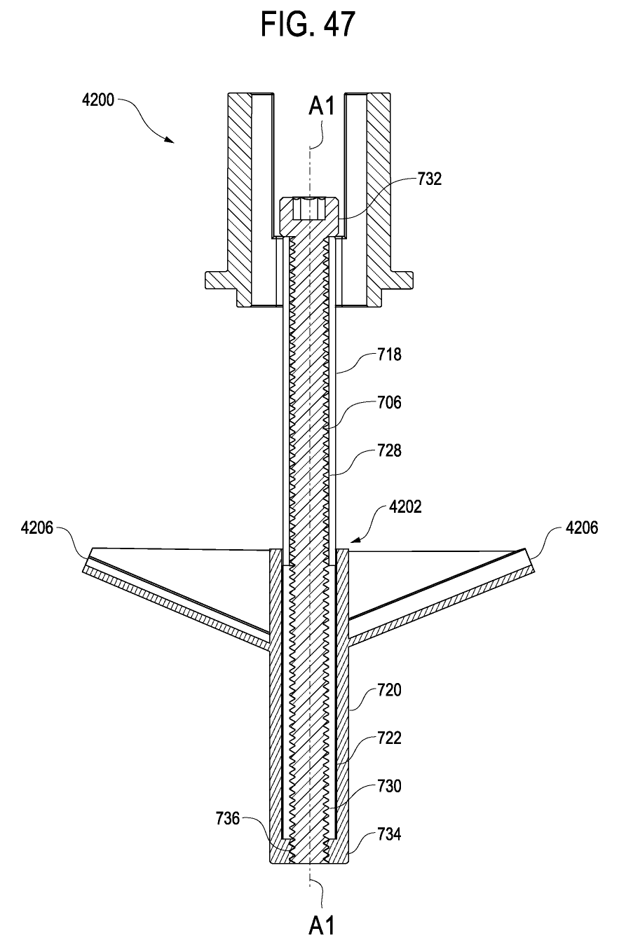

Referring to FIG. 45, the wings 4206 can be moved to the closed orientation as described above to fit through a hole in the countertop. Referring to FIGS. 44 and 47, the wings 4206 in the open orientation may extend outward from the sleeve 720 substantially perpendicular to the longitudinal axis A1. The wings 4206 may each project outward beyond the base 702 in the open orientation for engaging a bottom surface of the countertop. The wings 4206 may be arranged at diametrically opposite sides of the sleeve 720 such that the wings 4206 project in opposite directions when open. Alternatively, the wings 4206 may be arranged in a V-shape. For example, the wings 4206 may be arranged in a V-shape similar to the V-shape of the anchoring arms 3102 in the horizontal orientation described above with reference to FIG. 34. The wings 4206 may be arranged such that the wings 4206 in the open orientation allow clearance through the open ends of the base 702 for hoses, conduits, tubes, or other connections installed through the base 702 and the countertop.

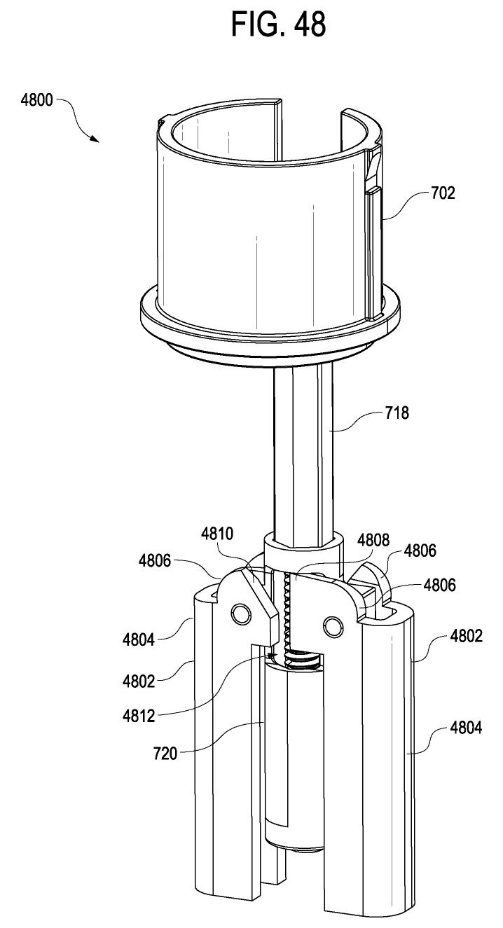

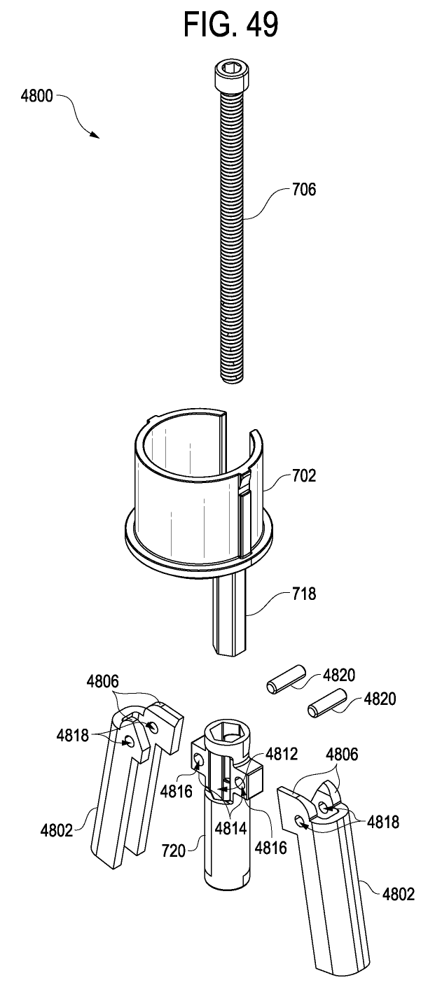

Turning now to FIG. 48, another example of a top mount installation that can be used to mount a fixture on a structure is shown isolated and indicated generally at 4800. The top mount installation 4800 can be used to mount any one of the faucets 100, 200, 300, 500 on the countertop 102, 202, 302, 502. Additional views of the top mount installation 4800 are provided in FIGS. 49-55. The top mount installation 4800 of this example may include similar elements and components as the top mount installations 700, 1600, 3100, 3700, 4200 described above. Like reference numbers are used to indicate like parts. For brevity and conciseness, differences between the top mount installation 4800 and the top mount installations 700, 1600, 3100, 3700, 4200 may be described. Similarities between the top mount installation 4800 and the top mount installations 700, 1600, 3100, 3700, 4200 can be recognized from FIGS. 7-55. Elements and components of the top mount installations 700, 1600, 3100, 3700, 4200 that are not labeled or explicitly described for the top mount installation 4800 are not necessarily excluded. The top mount installation 4800 can include any element or component of the top mount installation 700, 1600, 3100, 3700, and/or 4200, and vice versa, unless expressly stated otherwise or the context clearly indicates otherwise.

The top mount installation 4800 includes the base 702 and an anchor that is movable relative to the base 702 between a clamping position and a non-clamping position. The anchor may include one or more anchoring bars 4802 in this example. For example, the anchor may include two anchoring bars 4802. Each anchoring bar 4802 includes an anchoring surface 4804 and mounting brackets 4806 that are rotatably joined to the sleeve 720. One of the mounting brackets 4806 of each anchoring bar 4802 may include an engagement edge 4808 projecting outward relative to the anchoring surface 4804. The other one of the mounting brackets 4806 of each anchoring bar 4802 may include a clearance feature 4810, such as a chamfer.

The sleeve 720 may include windows or openings 4812 defined therein. The mounting brackets 4806 may be arranged such that the engagement edges 4808 are positioned at least partially within the windows 4812. The engagement edge 4808 of each anchoring bar 4802 may also face the clearance feature 4810 of the other anchoring bar 4802.

Referring to FIG. 49, the mounting brackets 4806 of each anchoring bar 4802 may be rotatably coupled to the sleeve 720 via a respective mounting lug 4814 of the sleeve 720. The mounting lugs 4814 may be located proximate the windows 4812. Each mounting lug 4814 may include a through hole 4816 that aligns with openings 4818 in the brackets 4806 of the respective anchoring bar 4802. Pins 4820 can be inserted through the aligned openings 4818 and through holes 4816 to rotatably couple the anchoring bar 4802 with the respective mounting lug 4814. A retainer, such as a nut or a bolthead, may be included to retain the brackets 4806 on the respective mounting lug 4814.

The anchoring bars 4802 are rotatable or pivotable relative to the sleeve 720 between a first orientation, here a horizontal orientation, and a second orientation, here a vertical orientation. The anchoring bars 4802 may move between the horizontal orientation and the vertical orientation for clamping and inserting through a hole in the countertop, respectively, similar to the horizontal and vertical orientations of the anchoring arms 1602, 3102. Rotation or pivoting of the anchoring bars 4802 relative to the sleeve 720 may be facilitated via the respective mounting brackets 4806 and the pins 4820 that rotatably couple the mounting brackets 4806 with the sleeve 720.

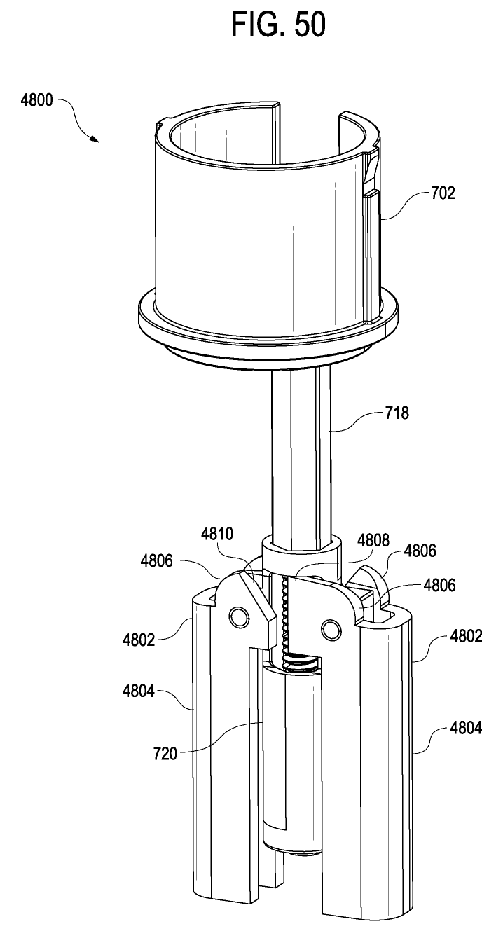

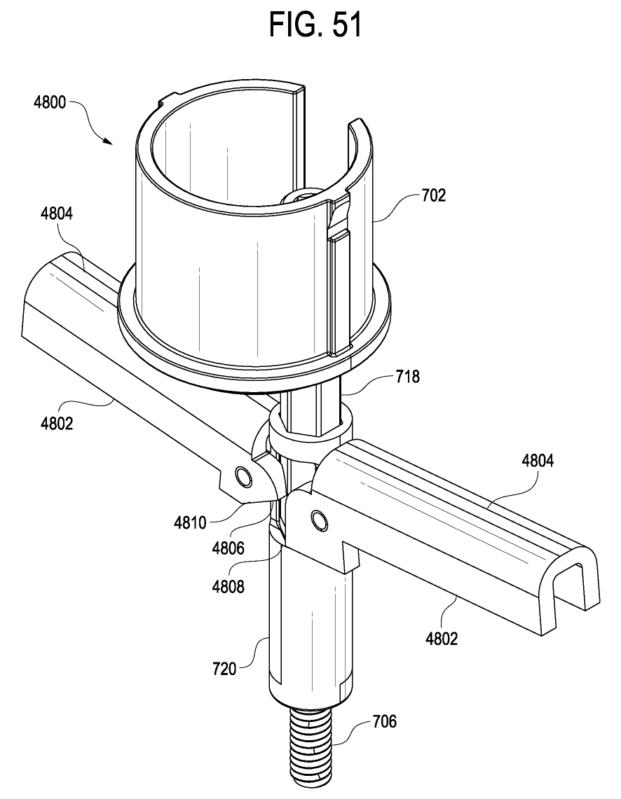

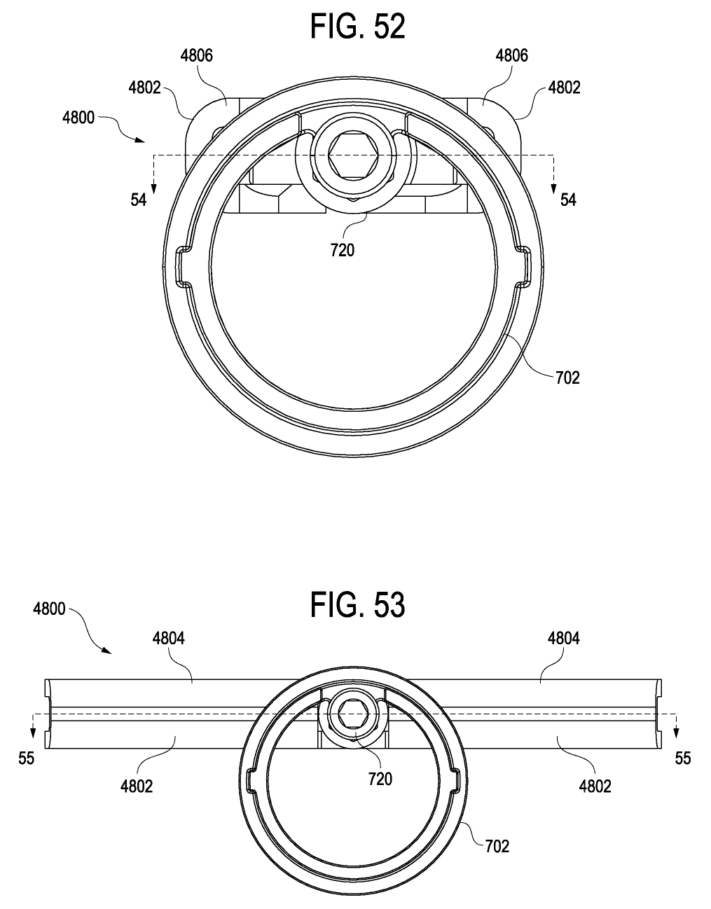

FIGS. 50 and 51 depict a sequence of the anchoring bars 4802 moving from the vertical orientation in FIG. 50 towards the horizontal orientation in FIG. 51. FIGS. 52 and 53 also depict the sequence from different views, with FIG. 52 showing the anchoring bars 4802 in the vertical orientation and FIG. 53 showing the anchoring bars 4802 in the horizontal orientation. The anchoring bars 4802 may be biased towards the vertical orientation via gravity and the weight of the anchoring bars 4802. The anchoring bars 4802 may move towards the horizontal orientation when the sleeve 720 moves upward along or relative to the shaft 718, as described below. The clearance features 4810 may allow the anchoring bars 4802 to rotate without the brackets 4806 of the anchoring bars 4802 interfering with one another or otherwise impeding rotation of the bars 4802. For example, the clearance features 4810 may provide clearance for the engagement edges 4808 to rotate without interfering with the bracket 4806 of the other anchoring bar 4802.

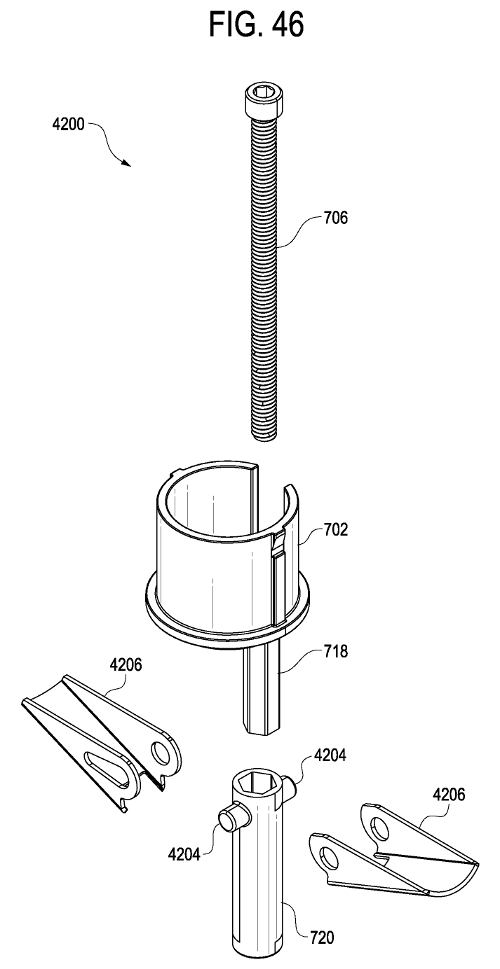

Referring to FIG. 52, the anchoring bars 4802 in the closed orientation may enable the sleeve 720 and bars 4802 to fit through a hole in the countertop. Referring to FIG. 53, the anchoring bars 4802 in the open orientation may extend outward from the sleeve 720 substantially perpendicular to the sleeve 720. The anchoring bars 4802 may each project outward beyond the base 702 in the open orientation for engaging a bottom surface of the countertop. The anchoring bars 4802 may be arranged at diametrically opposite sides of the sleeve 720 such that the anchoring bars 4802 project in opposite directions when open. Alternatively, the anchoring bars 4802 may be arranged in a V-shape. For example, the anchoring bars 4802 may be arranged in a V-shape similar to the V-shape of the anchoring arms 3102 in the horizontal orientation described above with reference to FIG. 46. The anchoring bars 4802 may be arranged such that the bars 4802 in the open orientation allow clearance through the open ends of the base 702 for hoses, conduits, tubes, or other connections installed through the base 702 and the countertop.

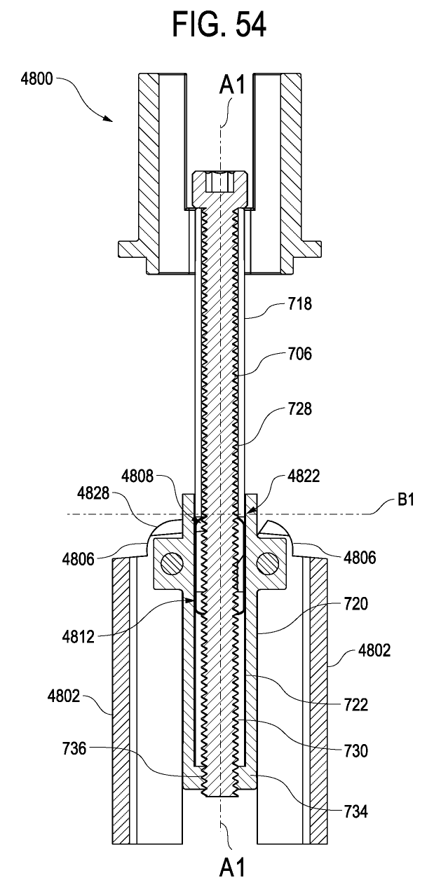

Referring to FIG. 54, the anchoring bars 4802 may be biased towards the vertical orientation when the brackets 4806 of the anchoring bars 4802 are located below a bottom 4822 of the shaft 718. The bottom 4822 of the shaft 718 may define a plane B1. The bottom 4822 of the shaft 718 may engage the mounting brackets 4806 to move the anchoring bars 4802 to the horizontal orientation. In particular, when the mounting brackets 4806 of the anchoring bars 4802 in the vertical orientation move above the plane B1, the shaft bottom 4822 may engage the engagement edges 4808. The engagement edges 4808 may be positioned in the windows 4812 as described above for engaging the shaft bottom 4822. The shaft bottom 4822 may engage the engagement edges 4808 to exert a downward force that initiates rotation of the anchoring bars 4802 to the horizontal orientation. Curved surfaces 4828 may transition from the engagement edges 4808 to translate continued engagement with the shaft bottom 4822 into rotation of the anchoring bars 4802.

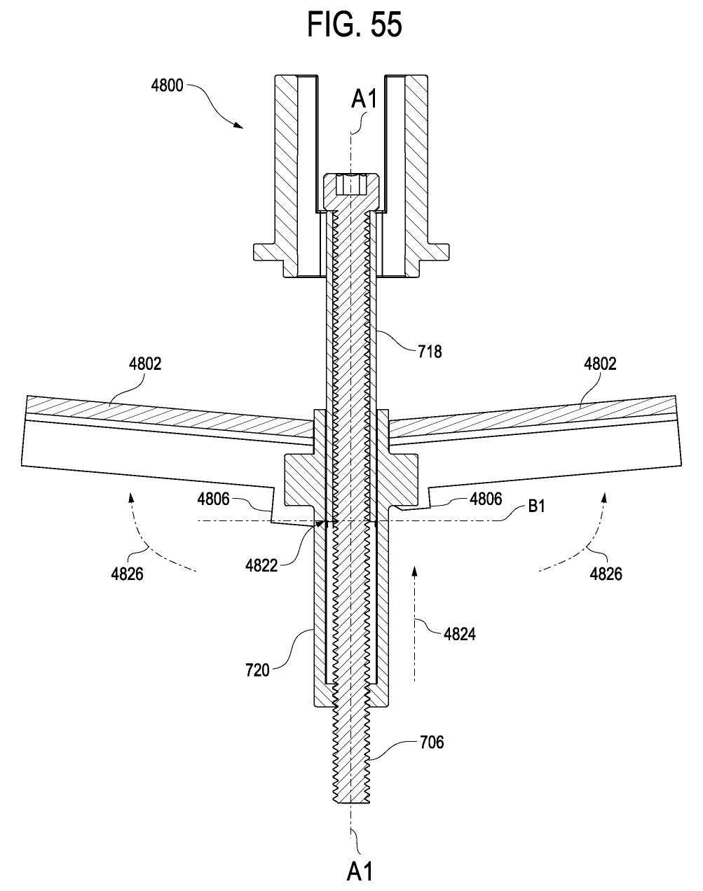

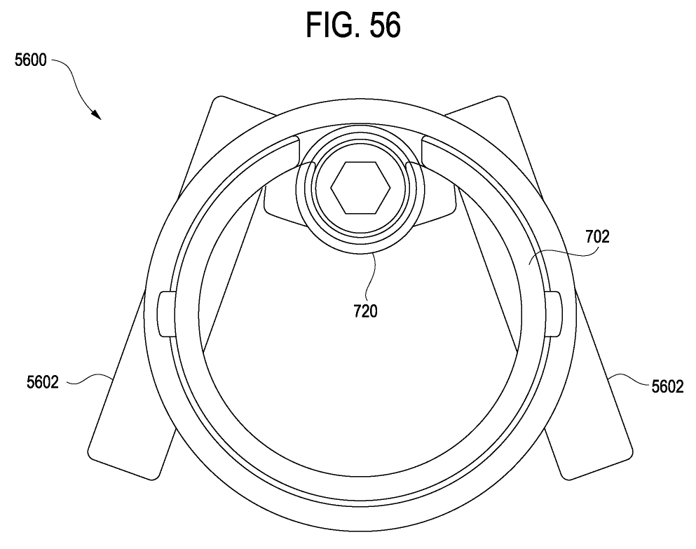

Referring to FIG. 55, the anchoring bars 4802 may move upward with the sleeve 720 along or relative to the shaft 718 towards the base 702. The sleeve 720 and the anchoring bars 4802 can move relative to the base 702 via a user manipulating the clamping bolt 706 as described above. As the clamping bolt 706 is tightened, the sleeve 720 and the anchoring bars 4802 may move upwards, indicated by the arrow 4824, along or relative to the shaft 718 relative to the longitudinal axis A1 towards the base 702. Continued upward movement 4824 of the anchoring bars 4802 above the plane B1 translates to rotational movement, indicated by the arrows 4826, of the anchoring bars 4802 to the horizontal orientation. The rotational movement 4826 may be enabled via engagement between the shaft bottom 4822 and curved surfaces 4828 transitioning from the engagement edges 4808. When the anchoring bars 4802 are in and/or moved towards the horizontal orientation, the engagement edges 4808 and/or the mounting brackets 4806 may cradle the shaft 718 to prevent the anchoring bars 4802 from prematurely rotating back to the vertical orientation. The anchoring bars 4802 can be moved back towards the vertical orientation when the clamping bolt 706 is loosened and the sleeve 720 and anchoring bars 4802 move downward such that the mounting brackets 4806 are below the plane B1.

Turning now to FIG. 56, another example of a top mount installation that can be used to mount a fixture on a structure is shown isolated and indicated generally at 5600. The top mount installation 5600 can be used to mount any one of the faucets 100, 200, 300, 500 on the countertop 102, 202, 302, 502. The top mount installation 5600 may be similar to the top mount installations 4200, 4800 described above. In this example, anchoring members 5602 of the top mount installation 5600 may be similar to the anchoring wings 4206 or the anchoring bars 4802 described above. In this example, the anchoring members 5602 are arranged in a V-shape in the horizontal orientation. The V-shape may allow clearance through the open ends of the base 702 for hoses, conduits, tubes, or other connections installed through the base 702 and the countertop.

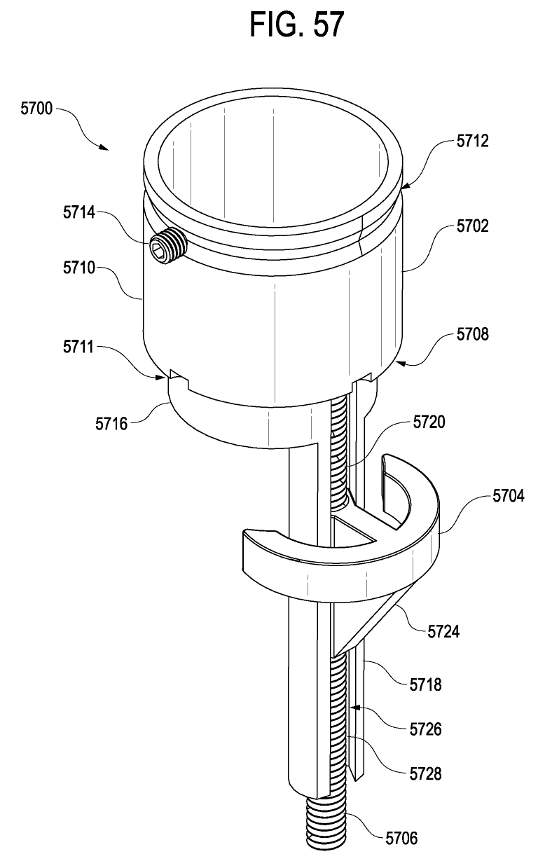

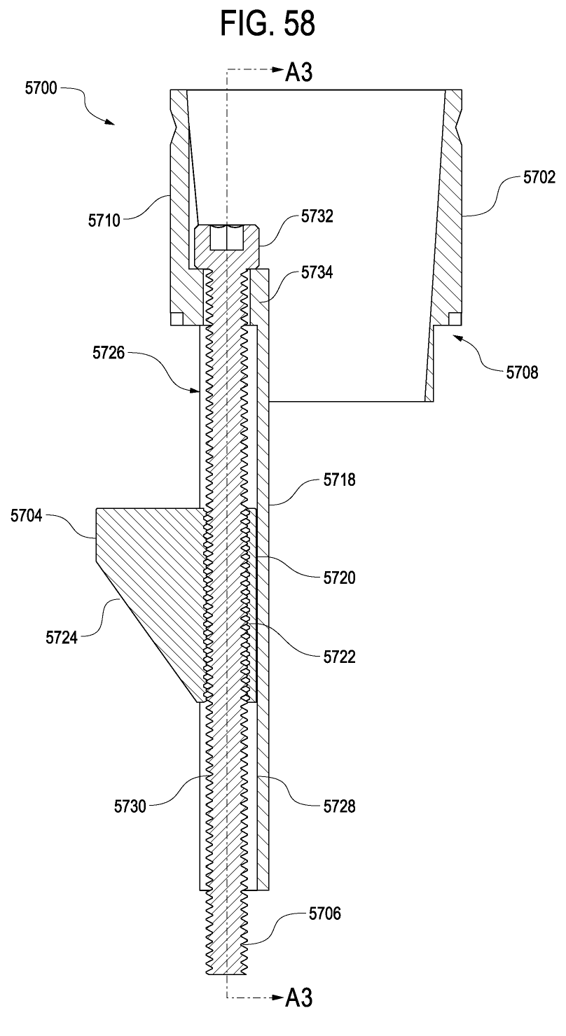

Turning now to FIG. 57, another example of a top mount installation that can be used to mount a fixture on a structure is shown isolated and indicated generally at 5700. The top mount installation 5700 can be used to mount any one of the faucets 100, 200, 300, 500 on the countertop 102, 202, 302, 502. The top mount installation 5700 of this example may include similar elements and components as the top mount installations 700, 1600, 3100, 3700, 4200, 4800, 5600 described above. The top mount installation 5700 can include any element or component of the top mount installation 700, 1600, 3100, 3700, 4200, 4800, and/or 5600, and vice versa, unless expressly stated otherwise or the context clearly indicates otherwise.

The top mount installation 5700 includes a base 5702 and an anchor 5704 that is movable relative to the base 5702 between a clamping position and a non-clamping position. The anchor 5704 may include an anchoring collar or horseshoe. Additionally or alternatively, the anchor 5704 may include any of the anchors 704, 1602, 3102, 3702, 4202, 4802, and/or 5602 described above. The anchor 5704 can move via a user manipulating a clamping bolt 5706 from a convenient location relative to the structure, such as above a countertop. In the clamping position, the anchor 5704 contacts a second surface, here a bottom surface, of the countertop. The anchor 5704 in the clamping position cooperates with a bottom 5708 of a cylindrical body 5710 the base 5702 to create a clamp on the countertop. The bottom 5708 contacts a first surface, here a top surface, of the countertop and limits or prevents the base 5702 from being fully inserted through the countertop. Additionally or alternatively, the bottom 5708 contacts a top surface of an escutcheon or another mounting structure positioned on the countertop.

Alignment features 5711 may be defined at or proximate the bottom 5708 of the cylindrical body 5710. The alignment features 5711 may mate with complementing alignment features on the countertop, escutcheon, or another mounting structure positioned on the countertop. The alignment features 5711 may include slots, recesses, grooves, keyways, or the like that receive complementing alignment features projecting upwardly from the countertop, escutcheon, or another mounting structure. Additionally or alternatively, the alignment features may project downwardly from the bottom 5708 and may be received by complementing alignment features, such as slots, recesses, grooves, keyways, or the like, depending into the top surface of the countertop, escutcheon, or another mounting structure.

The base 5702 may be open at both ends to enable a user to route conduits, hoses, or other connections through the base 5702 and the structure such as a countertop or an escutcheon. The base 5702 may include the cylindrical body 5710 that is positioned above, and in some instances on, the countertop when the top mount installation 5700 is installed. The cylindrical body 5710 defines the bottom 5708 that contacts the top surface of the countertop, escutcheon, or another mounting structure.

The body 5710 may be sized and shaped for insertion into a bottom of a fixture, such as a faucet spout or a handle of a faucet. The fixture may be secured to the body 5710 using a retainer 5714, such as a set screw, key, or another fastener. The body 5710 may define a circumferential groove 5712 for connecting the fixture to the body via the retainer. The circumferential groove 5712 may extend a suitable arc length to enable the fixture to be secured to the body 5710 at various angular positions of the fixture. For example, the circumferential groove 5712 may extend at least 90°, at least 180°, at least 270°, nearly 360°, or entirely 360° around the body 5710. The circumferential groove 5712 allows connecting the fixture to the body 5710 and orienting the fixture as desired by the user irrespective of the relative angular orientations between the body and the fixture. This can greatly simplify installation by eliminating the user having to position the top mount installation 5700 to a specific angular orientation that aligns with a desired orientation for the fixture.

The base 5702 also includes a pilot 5716 that aligns the base relative to the structure on which the fixture is mounted, e.g., the countertop. The pilot 5716 may be inserted in a hole in the structure, e.g., countertop, for locating the base 5702 on the countertop. Additionally or alternatively, the pilot 5716 may be inserted in a hole of an escutcheon or another mounting structure positioned on or relative to the structure, e.g., the countertop. The pilot 5716 may be long enough to extend within a hole in an escutcheon or another mounting structure and within a hole in the structure, e.g., the countertop. The pilot 5716 may engage within the hole(s) to limit or prevent lateral movement of the top mount installation 5700 relative to the structure, e.g., the countertop.

Like the top mount installations described above, the top mount installation 5700 may include an anti-rotation shaft 5718 and an anti-rotation sleeve 5720. The anti-rotation shaft 5718 may have an anti-rotation shape that complements a shape of the anti-rotation sleeve 5720. The complementing anti-rotation shapes may include, for example, polygonal shapes such as hexagonal, oblong shape, oval shape, or another anti-rotation shape such as any shape other than a circular shape. The anti-rotation shaft 5718 may engage the anti-rotation sleeve 5720 to limit relative rotation between the shaft and the sleeve. The anti-rotation shaft 5718 may be joined to the base 5702 and may extend downward from the pilot 5716. The anti-rotation sleeve 5720 may be joined to the anchor 5704. Features of the shaft 718 and the sleeve 720 described above apply to the shaft 5718 and the sleeve 5720 unless expressly stated otherwise or the context clearly indicates otherwise.

The shaft 5718 in this example receives the sleeve 5720 in a passage 5728 of the shaft. The sleeve 5720 may have the anti-rotation shape that complements an anti-rotation shape of the passage 5728. The sleeve 5720 may engage within the passage 5728 to limit relative rotation between the shaft and the sleeve. Description of the shaft 5718 and the sleeve 5720 received by the shaft applies to the other embodiments described herein unless expressly stated otherwise or the context clearly indicates otherwise. For example, the anchors 704, 1602, 3102, 3702, 4202, 4802, and/or 5602 described herein can be usable with and joined to a sleeve that is received by a shaft extending from the base.

The anchor 5704 may be joined to the sleeve 5720 via an outwardly extending connector 5724, e.g., a connector arm or a connector bar. A slot 5726 may be defined in the shaft 5718 that accommodates the connector 5724 between the anchor 5704 and the sleeve 5720. As such, the anchor 5704 can freely move with the sleeve 5720 relative to the shaft 5718 while the sleeve is received in the shaft. The shaft 5718 may include any number of slots to accommodate the connector(s) for joining anchor(s) to the sleeve 5720. For example, one anchor 5704 may be joined to the sleeve 5720 via one connector 5724 and the shaft 5718 may include one slot 5726 for the connector. Alternatively, the top mount installation may include multiple, e.g., two or more, anchors each joined to the sleeve by a corresponding connector and the shaft may include a slot for each connector.

The slot(s) 5726 may extend a length of the shaft 5718 to enable movement of the anchor 5704 and the sleeve 5720 relative to the shaft. The slot(s) 5726 may extend an entire length of the shaft 5718 or nearly the entire length of the shaft. The slot(s) 5726 may extend any suitable length along the shaft 5718 to enable movement of the anchor 5704 and the sleeve 5720 relative to the shaft. The slot(s) 5726 may also be partially defined in the pilot 5716. The slot(s) 5726 may extend an entire length of the pilot 5716 or nearly the entire length of the pilot. The slot(s) 5726 being defined in the shaft 5718 and the pilot 5716 may enable the anchor 5704 to move into close longitudinal proximity with the cylindrical body 5710 of the base 5702. In this way, the top mount installation may create a clamp on structures, such as countertops, having various thicknesses including relatively small thicknesses.

Referring to FIG. 58, the anti-rotation sleeve 5720 may define a bore 5722 that is aligned with the passage 5728 of the shaft 5718 along a longitudinal axis A3 when the shaft and the sleeve are engaged. The passage 5728 of the shaft 5718 and the sleeve 5720 may have complementing anti-rotation shapes such as, for example, polygonal shapes such as hexagonal, oblong shape, oval shape, or another anti-rotation shape such as any shape other than a circular shape. The anti-rotation shapes may limit or prevent rotation of the sleeve 5720 within the passage 5728. The sleeve 5720 may also fit within the passage 5728 by near interference fit. Preferably, some clearance is provided between the sleeve 5720 within the passage 5728 and the shaft 5718 such that the sleeve and the anchor 5704 are movable relative to the shaft 5718 in a direction of the longitudinal axis A3.

The clamping bolt 5706 can have a tail 5730 that is received by and extends through the passage 5728 of the shaft 5718 and the bore 5722 of the sleeve 5720 along the longitudinal axis A3. Each of the passage 5728 and the bore 5722 can be sized to accommodate the tail 5730 of the clamping bolt 5706 and allow the clamping bolt 5706 to rotate. A head 5732 of the clamping bolt 5706 may be seated at a top of the shaft 5718. The head 5732 may be sized and shaped such that the head 5732 is stopped at the top of the shaft 5718 and limited or prevented from being inserted in the passage 5728. The head 5732 may also be accessible via the open top end of the base 5702 and/or a cut-out in the body of the base to enable a user to manipulate the clamping bolt 5706 using a screwdriver, wrench, or another suitable tool. For example, the user may manipulate the bolt 5706 via the head 5732 using a screwdriver with a hex insert.

The shaft 5718 may extend downward from the base 5702 a suitable length such that the shaft can extend through and below the countertop when the base 5702 is positioned above the countertop. The top of the shaft 5718 may be proximate the bottom 5708 of the cylindrical body 5710 of the base 5702. The inner dimension of the passage 5728 may be sized to accommodate the tail 5730 of the clamping bolt 5706 and the anti-rotation sleeve 5720. The inner dimension of the shaft 5718 and the outer dimension of the sleeve 5720 may be sized to maintain anti-rotational engagement of the sleeve 5720 in the passage 5728. The inner dimension of the shaft 5718 and the outer dimension of the sleeve 5720 may also be sized to enable movement of the sleeve and the anchor 5704 relative to the shaft along the longitudinal axis A3.

The shaft 5718 may define a step or a stop 5734 proximate the top of the shaft that prevents further upward movement of the sleeve 5720 and the anchor 5704 relative to the shaft. A bottom of the stop 5734 may be proximate, flush, or nearly flush with the bottom 5708 of the cylindrical body 5710. As such, when the sleeve 5720 and the anchor 5704 reach the stop 5734 a small or infinitesimal longitudinal gap may exist, or a longitudinal gap may not substantially exist, between the bottom 5708 and the anchor 5704. This may allow the anchor 5704 and the bottom 5708 to clamp structures with relatively small thicknesses.

The bore 5722 of the sleeve 5720 may include threads that enable threaded engagement between the tail 5730 and the sleeve. The tail 5730 may be threaded to complement the threads within the bore 5722. The tail 5730 may have a suitable length to extend through the passage 5728 and the bore 5722. The tail 5730 may be long enough to extend through the passage 5728 and the bore 5722 without the sleeve 5720 being received in the shaft 5718. Alternatively, the sleeve 5720 may be at least partially received by the shaft 5718 before the tail 5730 can reach the threaded bore 5722.

The shaft 5718 may be positioned inward of the cylindrical body 5710 such that the longitudinal axis A3 extends through the open base 5702. The shaft 5718 may extend downward from the pilot 5716 and/or the bottom 5708 of the body 5710 without extending radially outward beyond the pilot 5716 so as not to interfere with engagement between the base 5702 and the countertop or mounting structure. The slot(s) 5726 defined in the shaft 5718 may face radially outward such that the connector 5724 and the anchor 5704 can project outward beyond the cylindrical body for clamping the bottom surface of the countertop.

To assemble the top mount installation 5700, the sleeve 5720 can be positioned relative to the shaft 5718 with the bore 5722 aligned with the passage 5728 along the axis A3. The sleeve 5720 can also be positioned such that the connector 5724 extends through the slot 7626 of the shaft 5718 with the anchor 5704 offset from the base 5702 relative to the longitudinal axis A3. The clamping bolt 5706 may be inserted in the bore 5722 and the passage 5728, and the sleeve 5720 can be received by the shaft 5718, in either order. The tail 5730 of the clamping bolt 5706 can rotate in the bore 5722 and the passage 5728 via a user manipulating the head 5732 of the clamping bolt 5706. The clamping bolt 5706 can be tightened via threaded engagement between the tail 5730 and the threaded bore 5722. As the clamping bolt 5706 is tightened, engagement between the threaded bore 5722 and the threaded tail 5730 may cause the sleeve 5720 and the anchor 5704 to move upward relative to the shaft 5718 and the longitudinal axis A3 towards the base 5702. Threaded engagement of the tail 5730 within the bore 5722 can translate rotation of the clamping bolt 5706 to axial or vertical movement of the sleeve 5720 relative to the shaft 5718 via the anti-rotational engagement of the sleeve 5720 within the passage 5728. This can eliminate the need for any additional tooling or other components to rotatably fix the sleeve 5720 and anchor 5704 relative to the shaft 5718 and/or base 5702 and simplify the assembly and clamping process using the top mount installation 5700.

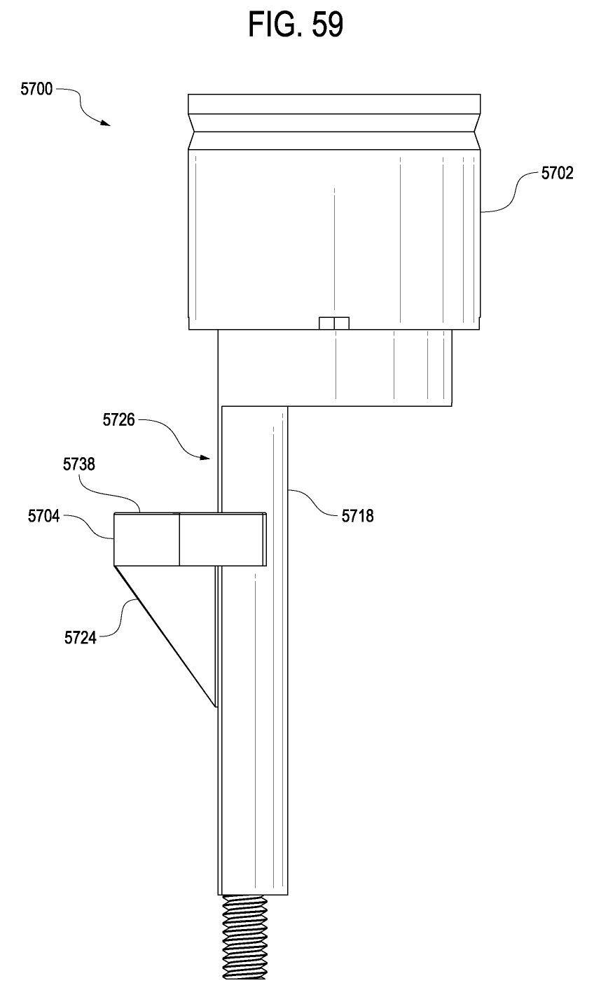

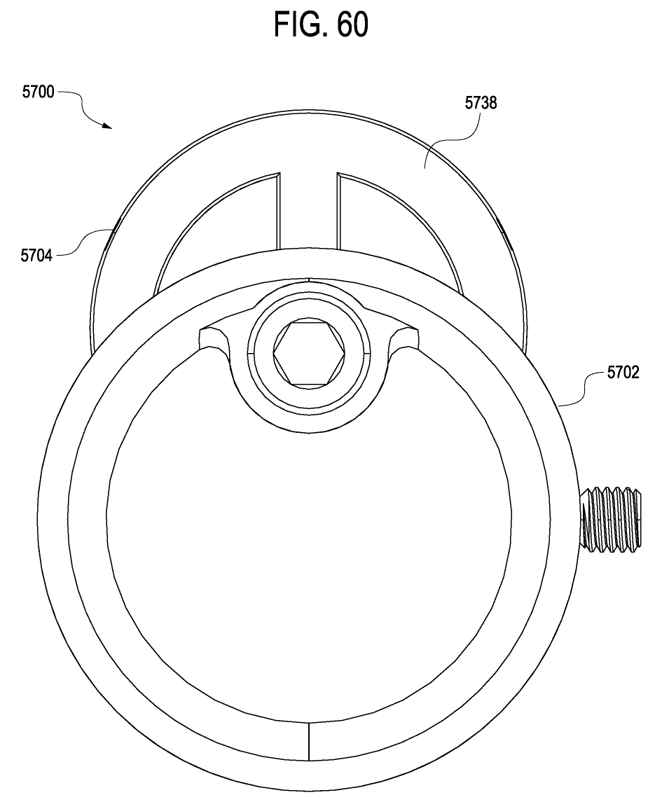

Referring now to FIGS. 59 and 60, the anchor 5704 may include the anchoring horseshoe that projects radially outward beyond the base 5702. The anchor 5704 defines an anchoring surface 5738 that may face the bottom of the countertop when the top mount installation 5700 is installed. The anchoring surface 5738 may also contact the bottom of the countertop when the anchoring collar 5704 is moved to the clamping position. The anchor 5704 is suitably shaped to fit through a hole in the countertop when the top mount installation 5700 is installed. The anchoring surface 5738 may be laterally or radially offset from the body 5710 of the base 5702. The offset between the anchoring surface 5738 and the body 5710 may position the anchoring surface below a bottom surface of the countertop when the base 5702 is positioned over the hole in the countertop such that the anchoring surface is positioned for contacting the bottom surface.

As discussed above, the anchoring horseshoe is one example of an anchor that can be used with the top mount installation 5700. Other anchors, including the anchors described elsewhere herein, can be used with the top mount installation 5700.

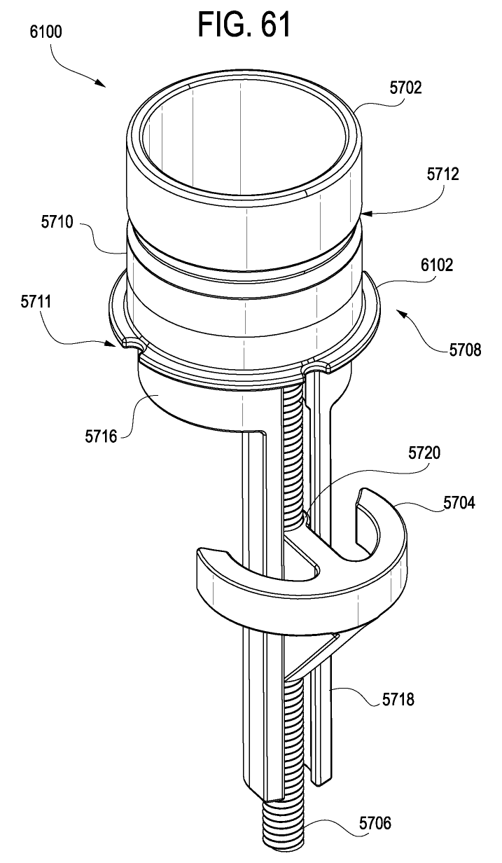

Turning now to FIG. 61, another example of a top mount installation that can be used to mount a fixture on a structure is shown isolated and indicated generally at 6100. The top mount installation 6100 can be used to mount any one of the faucets 100, 200, 300, 500 on the countertop 102, 202, 302, 502. The top mount installation 6100 may be similar to the top mount installation 5700 described above, with like reference numbers used to indicate like parts. Elements and components of the top mount installation 5700 that are not labeled or explicitly described for the top mount installation 6100 are not necessarily excluded, and the top mount installation 6100 can include any element or component of the top mount installation 5700, and vice versa, unless expressly stated otherwise or the context clearly indicates otherwise. In this example, the circumferential groove 5712 is defined in a middle portion of the cylindrical body 5710 of the base 5702. Additionally, in this example, the alignment features 5711 are defined in a flange 6102 that projects outwardly from the cylindrical body 5710 at or proximate the bottom 5708. The pilot 5716 may extend downwardly from the flange 6102.

The top mount installations 700, 1600, 3100, 3700, 4200, 4800, 5600, 5700, 6100 include example anchors that are movable relative to the base 702, 5702 via manipulating the clamping bolt 706, 5706. Rotation of the clamping bolt 706, 5706 is translated to upward movement of the anchor via anti-rotational engagement between the shaft 718, 5718 and the sleeve 720, 5720. The anchors that are usable with top mount installations in accordance with the present disclosure are not particularly limited. The anchors can include fixed anchors such as the anchoring collar 704 and/or horseshoe anchor 5704, movable anchors such as the anchoring arm(s) 1602, 3102, the butterfly anchor 4202, the anchoring bars 4802, and/or the anchoring members 5602, and/or flexible anchors such as the anchoring wings 3702. Other movable anchors, such as spring-loaded or actuable anchors, can also be used. Movable anchors can be manipulated via a user, via mechanical means (such as a cam mechanism or spring-loaded mechanism), and/or via a controller.

Features described for any one or more embodiments of a top mount installation can be incorporated in or combined with features of any other embodiment unless expressly stated otherwise or the context clearly indicates otherwise. Moreover, for any embodiment of a top mount installation described herein, the features of that embodiment are not limited to the particular combination and more, fewer, or other features, including features from any other embodiment described herein, can be included in that embodiment without departing from the scope of the present disclosure.

The top mount installations of this disclosure enable the user to clamp or mount a fixture on a surface of a structure from a readily accessible area adjacent to the structure. The top mount installations may reduce or eliminate the number of tasks that require the user to physically access areas adjacent to the structure that are hard or inconvenient to access or otherwise make the mounting process more difficult, time consuming, and/or dangerous. In the examples described, the top mount installations are used with countertops for the installation of faucets or other countertop fixtures. The top mount installations can be used with structures other than countertops, which can have a horizontal orientation like the countertops described above or can have a vertical or some other orientation. The top mount installations can additionally or alternatively be used to clamp or mount a fixture on a floor, wall, ceiling, or other desired structure.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. An installation for mounting a fixture on a structure having a first surface and a second surface, the installation comprising:
a base connectable to the fixture and positionable above the first surface;
an anti-rotation shaft extending from the base, the shaft including a central passage accessible via the base;
an anti-rotation sleeve engaging the anti-rotation shaft and defining a bore aligned with the central passage of the shaft; and
an anchor joined to the anti-rotation sleeve, the anchor having an anchoring surface configured to contact the second surface and create a clamp on the structure between the anchor and the base when the anchor is in a clamping position.

2. The installation of claim 1, wherein the anti-rotation sleeve engages a fastener, the fastener extending within the bore and the central passage of the anti-rotation shaft, wherein engagement between the fastener and the anti-rotation sleeve causes movement of the anti-rotation sleeve relative to the anti-rotation shaft.

3. The installation of claim 2, wherein the anti-rotation sleeve and the anti-rotation shaft have complementing anti-rotation shapes that limit relative rotation between the anti-rotation sleeve and the anti-rotation shaft during engagement between the fastener and the anti-rotation sleeve.

4. The installation of claim 2, wherein the fastener includes a bolt having a threaded tail that extends within the bore and the central passage, wherein the threaded tail engages threads within the bore of the anti-rotation sleeve.

5. The installation of claim 4, wherein the bolt includes a head that is accessible and manipulable by a user to rotatably engage the tail within the bore of the anti-rotation sleeve.

6. The installation of claim 4, wherein the anti-rotation sleeve receives the anti-rotation shaft at a first sleeve end and includes the threads at a second sleeve end opposite the first sleeve end.

7. The installation of claim 1, wherein the anti-rotation sleeve and the anchor are movable relative to the anti-rotation shaft and the base.

8. The installation of claim 7, wherein the anchor is movable relative to the anti-rotation sleeve.

9. The installation of claim 8, wherein the anchor is movable relative to the anti-rotation sleeve between a first orientation and a second orientation, the first orientation enabling the anchor to be inserted through a hole in the structure and the second orientation enabling the anchoring surface of the anchor to contact the second surface of the structure.

10. The installation of claim 9, further comprising a cam mechanism that moves the anchor relative to the anti-rotation sleeve between the first orientation and the second orientation.

11. The installation of claim 7, wherein the anchor is substantially fixed relative to the sleeve.

12. The installation of claim 11, wherein the anchoring surface is offset from a flange of the base.

13. The installation of claim 12, wherein the anchoring surface is substantially aligned with the flange of the base, wherein the anchor includes a flexible material that enables the anchor to flex inwardly when being inserted through a hole in the structure.

14. The installation of claim 1, wherein the anchor includes a butterfly anchor moveable between an open orientation and a closed orientation.

15. The installation of claim 14, wherein the butterfly anchor is biased towards the open orientation.

16. The installation of claim 1, wherein the anti-rotation sleeve receives the anti-rotation shaft.

17. The installation of claim 1, wherein the anti-rotation shaft receives the anti-rotation sleeve.

18. The installation of claim 1, wherein the base includes a circumferential groove for connecting the fixture to the base at various angular positions of the fixture.

19. The installation of claim 18, wherein the base comprises a cylindrical body having a bottom configured to engage the structure, wherein the cylindrical body defines the circumferential groove and a plurality of alignment features, and wherein the plurality of alignment features is configured to mate with complementing alignment features on the structure for aligning the installation.

20. The installation of claim 19, wherein the base comprises a flange proximate the bottom of the cylindrical body, and wherein the plurality of alignment features is defined in the flange.
